(19) United States
(12) Patent Application Publication
(10) Pub. No.: US 2022/0038264 A1
(43) Pub. Date: Feb. 3, 2022

(54) DECENTRALIZED KEY GENERATION AND DISTRIBUTION OVER A BLOCKCHAIN-BASED NETWORK

(71) Applicants: David YAKIRA, Tel Aviv (IL); Ido GRAYEVSKY, Tel Aviv (IL); Avi ASAYAG, Tel Aviv (IL)

(72) Inventors: David YAKIRA, Tel Aviv (IL); Ido GRAYEVSKY, Tel Aviv (IL); Avi ASAYAG, Tel Aviv (IL)

(21) Appl. No.: 17/278,641

(22) PCT Filed: Sep. 23, 2019
(86) PCT No.: PCT/US2019/052520

§ 371 Date: Mar. 22, 2021

Related U.S. Application Data
(60) Provisional application No. 62/735,096, filed on Sep. 22, 2018.
(60) Provisional application No. 62/735,109, filed on Sep. 22, 2018.

(51) Int. Cl. H04L 9/08; H04L 9/30; H04L 9/32

(52) U.S. Cl. CPC H04L 9/085; H04L 9/0825; H04L 9/3026; H04L 2209/56; H04L 9/3255; H04L 9/3271; H04L 2209/38; H04L 9/0838

(57) ABSTRACT

Systems and methods are disclosed for decentralized key generation. In one implementation, a first device is enrolled to a distributed key generation application. A local secret is generated, including a polynomial function and first coefficient(s). Commitment(s) are calculated for the polynomial function and transmitted to node(s) within a decentralized system. A value of the polynomial function is computed with respect to an identifying value that corresponds to a second device. The computed value of the polynomial function is encrypted with a public key of the second device and transmitted to one or more node(s). An encrypted value of the polynomial function computed by the second device with respect to an identifying value of the first device is decrypted and validated. The value of the polynomial function computed by the second device is combined with value(s) computed by other devices to generate a private key share associated with the first device.

### CROSS-REFERENCE TO RELATED APPLICATIONS

This application is related to and claims the benefit of priority to U.S. Patent Application No. 62/735,096, filed Sep. 22, 2018, and U.S. Patent Application No. 62/735,109, filed Sep. 22, 2018, each of which is incorporated herein by reference in its respective entirety.

### TECHNICAL FIELD

Aspects and implementations of the present disclosure relate to data processing and, more specifically, but without limitation, to decentralized key generation and distribution over a blockchain-based network.

### BACKGROUND

Data/records can be stored on a decentralized or distributed ledger such as blockchain that is synchronized across multiple computing/storage devices. Various cryptographic techniques can be utilized to secure such records.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates example scenario(s) described herein, according to example embodiments.

FIG. 3 is a flow chart illustrating aspects of a method for centralized key generation and distribution over a blockchain-based network, in accordance with an example embodiment.

FIG. 4 is a flow chart illustrating aspects of a method for centralized key generation and distribution over a blockchain-based network, in accordance with an example embodiment.

FIG. 5 is a block diagram illustrating components of a machine able to read instructions from a machine-readable medium and perform any of the methodologies discussed herein, according to an example embodiment

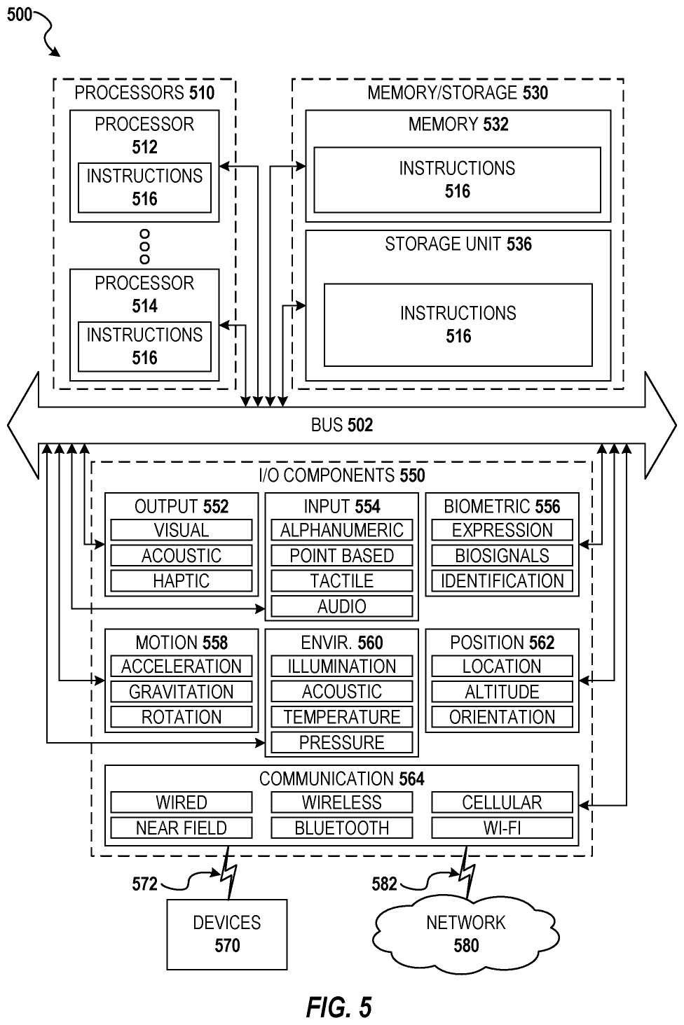

### DETAILED DESCRIPTION

Aspects and implementations of the present disclosure are directed to decentralized key generation and distribution over a blockchain-based network.

An example environment is depicted and described herein. In certain implementations, the described technologies can be implemented in conjunction with various nodes and users. For example, an example system can include a decentralized or distributed leger such as a blockchain that can be distributed/stored across multiple connected nodes. Examples of such nodes are depicted and described herein. As described herein, consensus algorithm(s) can be applied in relation to the referenced nodes. Such nodes may be employed in a permissioned or permissionless environment (e.g., using algorithms such as proof-of-stake or delegated proof-of-stake to map the nodes that participate in the protocol).

The referenced nodes can be computing devices, storage device, and/or any other such connected device or component configured to generate and/or provide verification (e.g., for a transaction, operation, etc.). Various nodes can be connected to one another (directly or indirectly) via various network connections, thereby forming a distributed computing environment or network.

In an example transaction, ownership of a digital token can be transferred from one address to another. To authenticate the transaction, the transaction recording the transfer can be signed by the originating party using a private key associated with that originating party (e.g., as stored on a device). Such a private key can be a cryptographic key (e.g., a string of bits used by a cryptographic algorithm to transform plain text into cipher text or vice versa) that may be kept secret by a party and used to sign transactions (e.g., the transfer of a token to another user, server, etc.) such that they may be verified using the described distributed computing environment.

The referenced signed transaction can then be broadcast across the distributed computing environment/network, where it can be verified, e.g., using the public key associated with the originating party. Such a “public key” can be a cryptographic key that is distributed to, or available to the referenced node(s) so that signed transactions associated with the public key may be verified by the nodes.

During the referenced verification process, the transaction can be accessed or selected by a consensus node (e.g., a device or ‘miner’ configured to verify transactions and add new blocks to a blockchain), verified using the public key, timestamped, and added to a “block” that includes other transaction(s).

Adding completed blocks to the blockchain ledger forms a permanent public record of various included transactions. The blockchain ledger can be replicated and distributed across multiple nodes within the distributed environment. In the event that a user tries to utilize a previously transferred digital token, the first transaction conducted using the token address may promulgate to remote nodes faster than any subsequently conducted transaction using the same token address. This allows more time for additional blocks to be added to the blockchain that include the first transaction In this scenario, a node that receives two separate chains that include blocks with transactions originating from the same token address will choose the longest chain, which should be associated with the first conducted transaction In such a manner, the blockchain may be used to provide verification of various operations, transactions, etc.

Described herein are systems, methods, and other related technologies in the realm of cryptographic systems, including in the area of systems which provide decentralized generation and use of cryptographic keys by multiple nodes in a network. In certain implementations, the described technologies may operate even if some of the nodes may be non-trusted, compromised, malicious or merely non-responding. The network may be decentralized with no single entity in control of its nodes and has no single trusted dealer.

In certain implementations, the described technologies can be configured to operate as a threshold cryptography system, in which a set of n nodes (e.g. servers) may cooperate to jointly generate a pair of public and private keys in such a way that the public key is output in the clear while the private key is generated divided into multiple shares, one of which is provided to each node (e.g., via a threshold secret-sharing scheme). In certain implementations, the complete private key may never be generated.

The nodes may further cooperate in using the generated key shares. For example, any subset of t+1 nodes (with t<n) may cooperate to perform functions requiring the use of the private key (such as signature computation or decryption)—without any of the nodes having actual knowledge of the full private key.

Additionally, the described technologies can be configured to provide integration with blockchain-based networks. In doing so, various advantages can be realized from their decentralized capabilities. For example, advantages and improvements can be related in areas such as documented communication, mediation, value store and computational power.

Threshold cryptography systems are systems in which in order to decrypt an encrypted message or to sign a message several parties (more than some threshold number) must cooperate in the decryption or signature protocol. In the encryption case, the message may be encrypted using a public key and the corresponding private key is shared among the participating parties. If n is the number of parties. Such a system is called (t,n)-threshold system, if at least t of these parties can efficiently decrypt the encrypted message, while less than t have no useful information. Similarly it is possible to define (t,n)-threshold signature scheme, where at least t parties are required for creating a signature.

Such a system can be implemented in multiple applications. For example, operations involving the use of highly sensitive keys, such as those guarding important identification information or a large amount of money. The system thus provides a high degree of confidentiality by having a highly sensitive key broken into shares and distributed between multiple nodes, making it extremely difficult for a malicious attacker to discover the secret information or sensitive key.

Some applications can be advantageously configured to be implemented via a threshold cryptosystem. Examples may include:

A key or password safeguarding a company bank account for which transactions specifically require “t+1 out of n” signatures.

A “t+1 out n” blockchain multi-signature.

A key escrow service—requiring multiple node approval for release of the escrowed key.

Another application area that can be advantageously configured to be implemented via a threshold cryptosystem is: providing common randomness (e.g., a shared random beacon, random oracle) among multiple non-trusting parties. This requires using unique threshold signatures (a subset of threshold signatures such as the BLS signatures discussed below), and allows the system to generate a common unpredictable, verifiable, random seed even in the presence of untrusted entities, with no an ability to predict or generate it without t+1 valid signatures.

Additional applications may include, for example, access control. This can be, for example, digital access control (i.e. enabling access to a given system or capability), physical access control or access control to some elements or capabilities of the underlying system nodes themselves.

Furthermore, in certain implementations key generation and distribution in such systems can be achieved without having a central trusted dealer which has the complete key at any given point in time—as such a central dealer may be a single point of failure for the system, and may also allow an attacker to access the highly sensitive key by breaching a single system. Accordingly, the generated key “belongs to the system”—it does not “belong to”, or even known by any single node or participant in the system.

Such a central trusted dealer is also highly susceptible to insider threat—being breached by an employee or sub-contractor having the appropriate data access permission as part of his or her job.

The discussion herein refers to key generation and key distribution as a unified operation (as the key shares are generated “within each node”)—unlike a system using a single trusted dealer, which may (for example) perform key generation internally, and then distribute key shares to separate nodes (e.g. using a specific one-to-one private communication channels for each node).

An attacker may attempt to interfere with the operation of the nodes in multiple ways. For example, an attacker may cause some of the nodes to be disabled, non-responding or malicious, or may otherwise attempt to corrupt the operation of the system. Having a threshold system in which the required operation can be completed with only t+1 of the nodes functioning provides a greater degree of reliability—an attacker would have to corrupt more than t nodes to prevent successful system operation In particular, an attacker may corrupt t+1 to be able to access the protected secret or perform joint signature (typically t<n/2). In the opposite case (t>n/2) an attacker corrupting (n−t) nodes may cause these nodes to freeze, thus preventing the system from functioning (e.g. as a quorum of t+1 cooperating nodes can't be achieved). The above is relevant to the distributed key use (DKU) stage, as any node corruption during the earlier distributed key generation (DKG) stage may be detected, causing the DKG process to stop and a per-(corrupted)-node deposit to be confiscated. These stages are further described below.

Accordingly, even though the objectives of confidentiality and reliability may, to some extent, conflict, a (t,n)-threshold system can provide high levels of confidentiality and reliability to be achieved simultaneously.

A threshold cryptosystem can also implement a challenge system, whereby a node may complain that another node is providing wrong results, attempts a malicious behavior or otherwise doesn't function properly. The system can provide a distributed mechanism to evaluate such challenges, and if such challenge is determined to be correct to disable or otherwise disregard the misbehaving node from this point on.

One element of the described threshold cryptosystem is a distributed key generation (DKG) element. The DKG element employs a DKG protocol, and is used to initialize the threshold cryptosystem, generate its private and public keys and distribute them to the nodes (with the private key divided into shares). The DKG protocol can be a sub-protocol of the entire threshold cryptosystem protocol.

The operation of the described threshold cryptography system can be divided into two stages:

The distributed key generation (DKG) stage, which may include key share generation as well as distribution.

The distributed key use (DKU) stage, in which the nodes engage in the primary system functionality (such as decryption or signature generation) using the generated key shares.

It should be noted that these two stages may not necessarily be distinct and may be repeated. For example, a system may implement ephemeral keys (generated per-session or even per-transaction)—requiring multiple DKG stages intertwined with the DKU stage. As another example, a system may implement a reset-like feature (based on consensus between the nodes) activated if a sufficiently large number of nodes are detected as disabled, un-cooperative or malicious. Such a “reset” may require the DKG stage to run again.

The discussion above focused on distributed key generation and distribution, with “distributed” referring to a system implemented on multiple nodes (computing units/servers) cooperating in a network, but, in certain implementations, still under control of a single entity. However, a system may implement decentralized key generation and distribution. The use of decentralized systems (which are a sub-class of distributed systems) can refer to systems implemented on multiple nodes which may belong to different organizations and are not controlled by a single entity.

It should be noted that the different nodes in a distributed system may often be under control of a single entity—and thus possibly subject to insider threat (e.g. from a system administrator employee of the single entity having the appropriate data access permission to some or all nodes). Conversely, a decentralized system may not have a single individual with such permissions, and thus offers a substantially better protection from insider threat.

Existing systems implementing DKG/DKU protocols can be required to implement a complex combination of capabilities and technologies to support the functionality described above.

These capabilities and technologies may include a combination of any of the following:

Establishing a private communication channel between every pair of nodes.

Implementation of a mechanism which allows proving the existence and details of communication in case of dispute.

Implementation of a mechanism to mediate a dispute under consensus.

In a decentralized system an incentive layer may be required such that nodes can be rewarded for honest behavior (or otherwise contributing to the system), and can also be penalized for dishonest behavior.

Accordingly, existing systems can require implementing and integrating multiple complex technologies, and may need to support them on multiple nodes, possibly employing different architectures, operating systems and deployment environments.

Doing so may be complex and costly to perform—especially when the system needs to support different systems and environments. Furthermore, the complexity of such integration may result in the creation of systems having various bugs and design flaws—which can then be exploited by an attacker.

Accordingly, the described technologies can be configured to provide decentralized key generation, distribution and use over a blockchain and without the presence of a trusted dealer or other central authority. Thus, it provides a solution for DKG/DKU between multiple parties who do not necessarily trust each other. It can also operate in an environment in which attackers may take over specific nodes and attempt to extract information from such nodes, hinder their operation or use the nodes to interfere with the operation of the protocols.

The described technologies can be implemented on top of Ethereum (including Ethereum specific optimizations) or on other blockchain systems that support general purpose code and assets that can be used for incentives. It may also employ off-blockchain calculation, so to offload expensive computations, using the blockchain computational ability to verify calculated results.

The by implementing DKG over blockchain, the described technologies can provide technical advantages and improvements including:

The blockchain provides a reliable means for communication among the parties. This may include pairwise communication between nodes using encryption (as further discussed below).

The blockchain enables a node to prove sent information and authenticate associated communication details as these are posted on the blockchain.

The blockchain supports using smart contracts for mediation in case of a conflict and as means to prove dishonest behavior without a need to trust a mediator.

The blockchain supports using value-carrying tokens as deposits for incentives. These can be used, for example:

To reward nodes for their work.

To penalize false challenges made by nodes.

To penalize a party which is dishonest, non-responsive or otherwise misbehaves.

To reward an honest challenger.

To reward nodes which verify other parties' behavior (i.e. decentralized arbitrator fees).

Accordingly, the described DKG/DKU system can be implemented on a blockchain, with the blockchain providing a common infrastructure to the multiple requirements noted above, and without requiring a central managing authority.

Such a DKG/DKU system which utilizes the multiple capabilities of the blockchain and is further optimized to specific blockchains (such as Ethereum) and makes appropriate use of off-chain computation can avoid the pitfalls described above. In particular, the addition of an integrated economic incentivization layer provides substantial benefits to the system's users (as compared to prior solutions), and can drive acceptance of the described technologies.

In certain implementations, the described technologies may use, for example, various DKG protocols.

In one embodiment, the described technologies can be configured to be optimized for the Ethereum blockchain. In such an implementation, the system can use Ethereum's precompiled contracts that were initially designed for fast (within the block gas limit) zkSNARK verification to implement a threshold Boneh-Lynn-Shacham (BLS) ([BLS04]) inspired signature scheme that can run efficiently over Ethereum. The system may use a BLS scheme which complies with the precompiled contracts that enable efficient Elliptic Curve (EC) arithmetic (over a specific curve) and type-3 pairing computations (from a pair of EC groups to a third (non-EC) group). As noted above, the system may also employ client-side computations (some of which may be implemented using external supporting libraries).

In certain implementations, the described technologies can incorporate modules/elements including:

The DKG Ethereum smart contract: This smart contract implements the DKG protocol noted above ([GJKR03]) among n Ethereum addresses and with a threshold parameter t. The keys generated in the protocol may suit any threshold cryptosystem over the specified Barreto-Naehrig (BN) curves (as detailed below). Specifically, the system can use the generated keys to realize a BLS inspired threshold signature scheme.

The contract may terminate successfully, leaving each participant with various pieces of information, including: A secret key share; a (general) public key; and individual public key shares for each node.

Alternatively, the contract may fail, invoking slashing of one (or more) dishonest participant(s) and splitting the slashed participant deposit(s) among the other non-slashed nodes, or among nodes involves in reporting the dishonest node as further discussed below. Such slashing may also involve restricting further participation of the slashed nodes in the protocol.

The DKG client program: This client program can be run by every node participating in the protocol. It is responsible for the expensive computations that may be better implemented outside of the smart contract. In case one of these computations yields an unexpected result, the client can “point” the smart contract to the problem. The smart contract can then detect any malicious behavior, running only the bare minimum as instructed by the “accusing” client.

The client program is also responsible for ongoing signing of messages. Upon request, it can publish a signature share, collect other nodes' signature shares and reconstruct the threshold signature. The client program can also verify individual signature shares and threshold signatures.

A DKU signature verification element: This is a system element which efficiently verifies (threshold) signatures or signature shares. Such an element can be implemented on each node requiring such verification. It can be implemented in the nodes themselves and can be implemented on-chain (i.e. via a smart contract) or off-chain chain.

Having the hash of the public data on the blockchain allows nodes who didn't participate in the DKG to easily verify generated signatures, as they could receive the require public information from a DKG participant node, and verify it against the hashes saved on the chain in the blockchain commitments block.

In certain implementations, the referenced modules can be configured to cooperate as noted above to deliver the DKG/DKU functionality as required.

Ethereum as a blockchain candidate for DKG: As noted above, the described technologies can use a blockchain (such as Ethereum) for various purposes. First, as a medium for communication, second as a mediating authority in case of conflicts, and third as a crypto-economic incentivization layer over the plain DKG protocol (providing appropriate economic incentives for “good” and “bad” behaviors). The described technologies can also be configured to make use of a smart contract computational capability to carry out some of the required calculations (e.g., in conjunction with a client-side application). The example embodiment described herein uses the Ethereum platform, chosen for its stability, reliability and widespread acceptance as well as specific optimization capabilities.

With regards to communication, the described technologies can be implemented with respect to a platform that allows timely communication which can be either public or private. For public communication the system can use Ethereum as a permanent, non-tamperable “blackboard” that anybody can write to (with properly paying a fee (gas) and at a designated location (contract storage)). This way, anyone can see the details of the communication, including parties who don't participate in it. Ethereum can also be used for private communication by employing (for example) a Diffie-Hellman (DH) key exchange algorithm to establish a shared (and secret) symmetric encryption key between any two parties.

In both communication forms, the described technologies can require participants to have their transactions included in the blockchain up to a predetermined block height. If the participants fail to do so, the system may regard them as offline and/or not participating. Indeed, if this interval is long enough there shouldn't be censorship issues. To deal with censorship attacks and other delays (which may occur during highroads of the Ethereum network) we fix a block height which is high enough. The choice of the block height is made to guarantee that in any scenario, all participants are guaranteed to have their transactions included in the blockchain.

Furthermore, as the protocol used by the described technologies does not depend on the order in which the different nodes send their transactions, it is fully resistant to front running attacks.

As a mediating authority, Ethereum can be a very reliable platform. However, challenges exist, including: Connecting Ethereum to external oracles; and conducting expensive computations over Ethereum.

The described technologies can solve these problems by having a client program do the expensive computation and instruct the smart contract what computation to conduct. The smart contract would then be required to redo only the instructed computation and make a decision who is to blame.

Finally, Ethereum would drive its deterrent force by having participants deposit Ether to the smart contract in order to participate. Then, if the smart contract decides a specific node hasn't complied with the rules, the smart contract could punish that node by slashing her deposit, splitting it among the rest of the nodes. Alternatively, the slashed funds may be used to reward the challenger on an honest challenge. This would serve as a means to incentivize correct and timely communication.

Parameters: The described technologies can use a number of primary parameters as described below.

n (e.g., 22). This is the total number of participants in the threshold signature scheme. The first n Ethereum addresses to send valid enrollment transactions (as described below) can be included in the protocol (on first-come-first-served basis). Alternatively, the participants' addresses can be hard coded into the smart contract. Regarding hard coded addresses in contracts, any node may deploy a contract (which may include specific authorized addresses). There may be no need for such node to be trusted, as any user can independently verify the deployed smart contract (against the publicly available code) and the addresses included in contract (as these he would like to cooperate with). If the user is not satisfied with these (or any other element of the smart contract or its deployment), the user may simply not enroll. It should be noted that in certain implementations, the described technologies can be employed in a permissioned mode, i.e. the participating nodes are typically familiar with each other, and their addresses may even be known in advance.

t (e.g., 14). This is the threshold for producing a threshold signature. t+1 signature shares can be required to produce a threshold signature. In our case, t is the maximal number of bad faith nodes (also known as Byzantine nodes) the system can handle and still function.

epoch (e.g., 120). This is the amount of blocks a phase would last. The system may have certain phases longer than others as an optimization. 120 blocks ≃30 minutes.

X. The deposit (in Ether) required from each node in order to participate.

γ. A generator group element for the encryption group for the Encryption scheme to allow private communication channel among participants of the protocol.

The system setup can involve a number of parameters, with an example one such parameter choice described below. The system can use these ECs and subgroups as they have precompiled contracts (as mentioned previously):

P=21888242871839275222246405745257275088696311157297823662689037894645226208 is a (safe) prime number. Numbers in Fₚ can be represented as 256-long bit numbers.
q=21888242871839275222246405745257275088548364400416034343698204186575808495 is a (safe) prime number. Numbers in F_{q} can be represented as 256-long bit numbers.

G₁. An EC group. Messages that should be signed would be first mapped to G₁.

We consider E₁/Fₚ under the equation y³=x³+3.

g₁=(1,2)∈E₁/Fₚ.

G₁=(g₁)≤E₁/Fₚ is a subgroup of order q.

l₁. number of bits to represent a G₁ EC point.

G₂. An EC group. Public keys would come from G₂.

We consider E₂/Fₚ under the equation

$${y}^{2} = {x}^{3} + \frac{3}{\text{?}} . \\ \text{?} \text{indicates text missing or illegible when filed}$$

a₁=10857046999023057135944570762232829481370756359578518086990519993285655852.
a₂=115597320329863871079910040213922857839258128618211925309174031S14S2391805.
b₁=84956539231234314176049732474892724384181905872636001487702806493069581019.
b₂=408236787S8634336813322034031454355683168513275934012081057410762141200935.

g₂=(a₁+a₂i,b₁+b₂i)∈E₂/Fₚ.

G₂=(g₂)≤E₂/Fₚ is a subgroup of order q.

l₂. number of bits to represent a G₂ EC point.

G_{T}. The order q subgroup of the multiplicative Abelian group underlying G_{q}_{²²}. This group would be used to verify signatures utilizing a bilinear pairing.

e:G₁×G₂→G_{T} is a type-3 pairing.

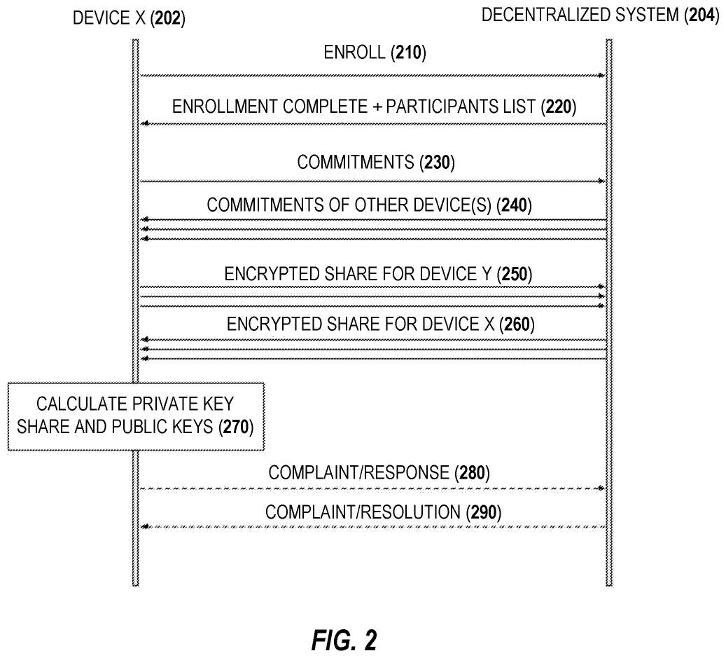

FIG. 2 depicts aspects of various phases or operations of the described technologies. As shown in FIG. 2, a smart contract can be deployed across a decentralized system (204) and various devices (e.g., ‘Device X’ 202) can be enrolled (or the enrollment can begin by a special opening-shot transaction) (210). This process can ends when the first of the following two happens:

Either, n Ethereum addresses have sent valid enrollment transactions with deposits (in which case the contract advances to phase 2); or epoch blocks have passed since the enrollment phase began (in which case anyone could send an abort transaction that would return the deposits and kill the contract).

Commitments phase (230, 240) can start after the enrollment phase has ended and can last for epoch blocks or until all participants' commitments transactions have been included in blocks (the first). Once Ethereum's block height passes a specific height (aid there are still commitments transactions missing), any Ethereum address is eligible to send a revoke transaction that would split the deposits of the participants who failed to send their commitments transaction (one or all of them) among those who did and would then kill the contract. It should be noted that the revoke transaction may only function if sufficient time has passed and not enough nodes have enrolled—and thus no harm is done if an attacker (possibly a non-participant node) seals one or more spurious revoke transactions. Otherwise, if all the commitments transactions came on time the contract moves to the shares phase.
The Shares phase (250, 260), can starts after the commitments phase and lasts for epoch blocks or until all participants' shares transactions have been included in blocks (the first).
In the verification phase (270), the nodes (e.g., ‘Device X’ 202) verify (locally) the information that was published by the rest of the nodes (e.g., ‘Device Y’) in the commitments phase and share phase (e.g., 240, 260). If these checks pass, the contract terminates successfully. Otherwise, complaint transactions are filed and slashing is invoked—either of the dishonest nodes, or of the nodes that filed complaints (280, 290). If no complaint has been filed during epoch blocks (since the verification phase has begun), a terminate transaction can be published, killing the contract and returning the deposits to the original depositors. One implementation of the system may support a single complaint transaction and may also provide limited slashing capability (e.g. limited to a single node being slashed).

The described implementation employs a complaint zero-tolerance system. Thus, whenever a single complaint is filed by node A against node B. it can be immediately evaluated. If the complaint is true, node B is slashed. If the complaint is false, node A is slashed. Either way, the DKG process would stop and no key would be generated.

An alternative embodiment can allow for handling of multiple complaints. In such an embodiment, the contract would delay for a given number of blocks and evaluate all complaints filed by that time. The contract could then slash multiple bad actors (misbehaving nodes and false complainers) simultaneously and divide their deposits in a single round. This would save considerable time and effort to all participants if (for example) an attacker took control of multiple nodes during the same time—as it would otherwise require running multiple rounds of the DKG phase and slashing only one bad node in every round.

Regarding the slashing mechanism:

In certain implementations at the enrolment phase, participants deposit Ether to the smart contract.

The protocol specifics a mechanism which detects incorrect behavior and penalizes the incorrect party. This is done, for example, as follows: in the DKG scheme, any incorrect behavior can be detected by (at least) one participant. If a participant detected such behavior, it may file a complaint to the smart contract, along with the necessary data which allows the smart contract to decide unambiguously whether there was indeed an incorrect behavior, or was it a false complaint.

In the former case the deposit of the party who behaved incorrectly is slashed and distributed among the other participants of the protocol. Otherwise the deposit of the false complainer is slated and distributed among the others.

Either way, the slashed party is barred from future participation.

In an alternative embodiment, a justified complaint may reward justified complainer(s) with a larger share of the slashed deposit(s) as compared to other participants.

DKG (smart contract): in certain implementations, there various essential transactions in the smart contract, a transaction per phase as detailed below. In addition, the protocol may include additional optional supporting transactions, such as:

Opening-shot transaction.

Abort transaction.

Revoke transaction.

Complaint transaction.

Terminate transaction.

The present disclosure pertains to certain essential transactions. In some cases, specific implementation details have been described (e.g. a specific symmetric encryption/decryption scheme), and alternative implementation methods may be used as well. In particular, many of the below transactions may be mapped into precompiled Ethereum contracts.

Tx1—Enrollment transaction. The transaction includes:

γ^{ξ}—a public key for encryption. Anyone can encrypt a message using this public key. Only the node that generated ξ may be able to decrypt it. This may be done using a multi-party DH key exchange algorithm.

X ETH as a deposit.

An Ethereum address with a corresponding signature.

The first n Ethereum addresses to send X ETH to the smart contract can be included in the protocol—they get a serial number from the smart contract (as controlling the order of the participants has no significance in the protocol whatsoever) and only their transactions would be processed by the smart contract. The n'th address to enroll would kick start the second phase of the protocol.

Each enrolled node can be identified by identifiers such as: an Ethereum address; the serial number assigned by the smart contract, from 1 to n; and the encryption scheme public key (generated locally by each participant).

Size: 256-512 bit.

Computation: None.

Tx2: Commitments transaction. Includes (for node i):

t+1 E₁/Fₚ curve points and t+1 E₁/Fₚ curve points {((X¹ᵢₖ,1),(X²ᵢₖ,2)}_{k=0 . . . t}. These would be generated on the client side: node t chooses a random polynomial fᵢ(z)=Σₖ₌₀^{t} aᵢₖ x^{k}∈F_{q}[X] of degree t. This amounts to randomly choosing coefficients aᵢₖ∈F_{q} for 0≤k≤t. Node i then computes the commitments Xⁱᵢₖ=g₁^{a}^{ᵢₖ}, X²^{ᵢₖ}=g₂^{a}^{ᵢₖ} and sends them to the smart contract as an Ethereum transaction which writes these values in node i's state. Anybody with access to an Ethereum node can view those Xᵢₖs (for any participant i).

An Ethereum address with a corresponding signature, that corresponds to node i's Ethereum address as listed in the contract's state.

Here we use the Ethereum blockchain as a public “blackboard” over which the participants publish commitments to their local random values.

Size: t+1 G₁ points and t+1 G₂ points. In total we get n×l₁+n×l₂ bits.

Computation None.

Tx3: Shares transaction. Includes (for node i):

For each l≠i, (eᵢⱼ,j), where eᵢⱼ=ENC(m=xᵢⱼ=fᵢ(j),k)=xᵢⱼ⊕H(key) and key=(γ^{ξ}^{ⱼ})^{ξ}^{ⱼ}. These can be calculated on the client side: node i reads γ^{ξ}^{ⱼ} from node j's state and calculates xᵢⱼ=fᵢ(j)=Σₖ₌₀^{t} aᵢₖ j^{k}. We note that even though the ciphertext eᵢⱼ would be written on the “blackboard”, only node j would be able to produce the corresponding plaintext fᵢ(j).

An Ethereum address with a corresponding signature, that corresponds to node i's Ethereum address as listed in the contract's state.

Size: n−1 encrypted shares, each share of size ˜256 bits (an element in Fₐ). In total we get (n−1)×256 bits, and there should be n such transactions. For this n=22 would be ˜15 KBytes (maybe with the encryption even more). The costs associated with the system are acceptable in terms of storing data on the blockchain. 1 MByte of data would cost ˜5500$ (based on current average gas prices) and would require splitting the data along ˜150 blocks. The system may require <1 KByte per node which can easily be included in a single block and would cost ˜5.5$.

Computation None.

Tx4: Complaint transaction. In case node i's (local) verification computations detected a dishonest participant j, she would send a complaint transaction. She would, fir example, let the smart contract run her local verification computations so that the contract slashes j (if indeed found dishonest). In practice this transaction would be broken into smaller transactions indicating exactly where the problem occurred.

This way the smart contract would be able to run as few computations as possible. If no complaint has been filed during epoch blocks, the smart contract would “declare” successful termination and the nodes would be able to finish off any last computations (as indicated by the client).

Includes (for node i):

The id of an allegedly dishonest participant, j.

Node i's secret decryption key, ξᵢ.

An Ethereum address with a corresponding signature, that corresponds to node i's Ethereum address as listed in the contract's state.

Computation:

Verity that the secret decryption key, ξᵢ, matches the public encryption key that i has published in her enrollment transaction. If this fails, slash i. Otherwise, continue.

Check that γ^{ξ}^{ᵢ} is indeed in the encryption group. If it's not, slash i, else continue.

Decrypt the share node j sent to node i, that is dⱼᵢ=DEC(eⱼᵢ,sk=ξᵢ)=eⱼᵢ⊕H(k), where k=(γ^{ξ}^{ⱼ})^{ξ}^{ᵢ}. This is what node i reads as xⱼᵢ. Calculate g₁^{d}^{ⱼᵢ}.

Check that X¹ⱼₖ for every k=0, 1, . . . , t is indeed in G₁. Explicitly: check (X¹ⱼₖ)^{ij}=idᵢ. If equal, slash i, else slash j.

Check G_2 membership the same way.

We use the pairing to verify compatibility of commitments. That is, check e(X¹ⱼₖ,g₂)=e(g₁,X²ⱼₖ) for every k=0, 1, . . . , t. If at least one of the checks fails slash i, else continue.

Calculate

$$\text{?} = \text{?} = \text{?} \text{?} = {\prod }_{k = 0}^{t} {( {X}_{jk}^{1} )}^{{i}^{k}}$$

$$\text{?} \text{indicates text missing or illegible when filed}$$

according to node j's commitments transaction.

Finally, if g₁^{d}^{ⱼᵢ}≠g₁^{f}^{ⱼ}^{⁽ⁱ⁾} slash j. Else, slash i.

Gas: ˜700,000 (×33,333 a simple Ethereum transaction) for the calculation step (vi) above alone according to a sample implementation we with Ethereum precompiled contracts over alt_bn128.

Size: 512 bits (expected).

Note: This transaction may invoke quite expensive computation In some cases the cost may not be a major consideration, but the calculation may also exceed Ethereum's the block gas limit. This may be handled by dividing this computation into multiple transactions if necessary. These transaction can cooperate as required to perform the complete computation.

Note: in certain implementations this step may only take place only if a complaint is filed against a malicious participant, so the system may function properly even if the step is substantially more expensive than other steps. A complaining node can still find it worthwhile to complain, assuming the potential reward is large enough based on the size of the initial (enrollment) deposit.

DKG (client program): The client can also be configured to operate in relation to the phases described above.

In the first phase a client enrolls to the smart contract. In the second phase it generates a polynomial and publishes a commitment transaction, committing to the coefficients it sampled. In the third phase it evaluates the polynomial in different points (the indices of the other nodes), encrypts each evaluation and publishes the ciphertext. In the fourth phase, the client reads all the other nodes' commitments and the ciphertexts designated to it and executes locally all the computations in Tx4 to make sure there are no problems. If a problem is detected it sends a complaint transaction, otherwise it waits.

The protocol terminates epoch blocks after phase 4 has begun. At that point the client may send a termination transaction to the contract (maybe killing it). After the protocol has terminated the client “finishes up”, calculating the public key, its own secret key share and the public key share of every node. For node i that is:

PK=g₂^{f(0)}=g₂^{Σ}^{ⱼ₌ᵢ}^{ⁿ}^{fj(0)}=Πⱼ₌₁ⁿ g₂^{fj(0)}. Where,

$$∀ j = 1 , 1 , … , n ; {g}_{2}^{{f}_{j} ( 0 )} = \text{?} = {\prod }_{k = 0}^{t} \text{?} = {\prod }_{k = 0}^{t} {X}_{jk}^{2}$$

$$\text{?} \text{indicates text missing or illegible when filed}$$

Note that for j=i this computation is unnecessary as i knows fᵢ(0)=aᵢ₀. Note that nobody knows f(0) and i only knows fᵢ(0).

Similarly, Πₖ₌₁ⁿ (Πₖ₌₀^{t} g₂^{a}ₖᵢⱼ_{ₖ})=Πₖ₌₁ⁿ (Πₖ₌₀^{t} (X²ₕₖ)^{j}^{^{k}}).

sksᵢ=f(i)=Σⱼ₌₁ⁿ fⱼ(i). Note that node i knows all fⱼ(i) and can thus compute f(i) easily. Note that only node i knows f(i).

Once the protocol terminates, the DKG process has terminated. The node may continue to use the key shares available to them to perform further decryption/signing/etc. using a separate protocol. The client intermediate may be stored in order to allow generation of keys for additional nodes without re-invoking the protocol.

Signature Scheme (client program) (Threshold BLS): This client can have functionalities such as:

Sign a message (or, produce a signature share for a message).

σ_{m,j}=sign(m,sksⱼ)=H(m)^{skz}^{ⱼ}=H(m)^{f(j)}∈G₁. Publish {m, σ_{m,j}} (we assume that pkⱼ=g₂^{f(j)} is known).

Verify a (threshold) signature (or a signature share) σ for message m that should correspond to public key pk.

If e(H(m),pk)=e(σ,g₁) then return YES, else return NO.

Reconstruct a threshold signature from t+1 valid signature shares.

Anyone that collects t+1 signature shares from nodes S={jᵢ}ᵢ₌₀^{t} does:

Verifies every signature share is correct, e(σ_{m,ji},g₂)=e(H(m),g₂^{f(j}^{ᵢ}⁾).

Reconstructs the threshold signature,

$${σ}_{m} = {H ( m )}^{f ( 0 )} = \text{?} = {\prod }_{i = 0}^{t} ( H ( m \text{?} = \text{?} \text{?} \\ where \\ \text{?} = \text{?} \text{?} \\ \text{?} \text{indicates text missing or illegible when filed}$$

(Lagrange interpolation).

Note that, in certain implementations, for the signature scheme the system may need a mapping from the message space in {0,1}* to G₁. We denoted this mapping by H above. The mapping described in [BLS04] can be used in one implementation.

Signature Verification (smart contract): In this smart contract the system may use the pairing precompiled contract in order to verify signatures. The relevant public key needs to be published with the signature. The message hash (an element in G₁) may also need to be published.

Offloading calculation from the blockchain: This system can be interpreted as a “private case” of a mechanism (such as Plasma) that enables transferring on-chain computations off-chain. If a dispute arises between two parties, on-chain computation can kick in and settle it. It should be noted that the disclosure above may not be fully optimized so to reduce the amount of on-chain computation Additional optimizations are further discussed below.

In order to reduce the interaction with Ethereum even more, the described system may implement the following:

The commitment and shares transactions may not be submitted to the network and would not touch the blockchain. Instead, they can be transferred between the participants. In case of a problem, a node could submit any of those transactions to the network.

Every node can submit a digest of her commitment and shares transactions to the network in the form of a digests transaction.

In case a node detects a problem she can submit the relevant commitment transaction and/or shares transaction and file a complaint just as in the current spec.

Further Optimizations can include:

Commitment and Shares phases (phases 2 and 3) can be united into a single commit phase where the participants publish their data, either encrypted and destined to a specific node or transparent for everybody to see.

The system can further implement a pre-commit phase to mitigate the last-actor attack for public key manipulation In such a phase participants can commit to g₂a₀ but not yet reveal it. In the commit phase they would reveal g₂a₀ and the commitment would be verified locally. In case of a failure, a special complaint transaction would be filed to Ethereum.

A

A

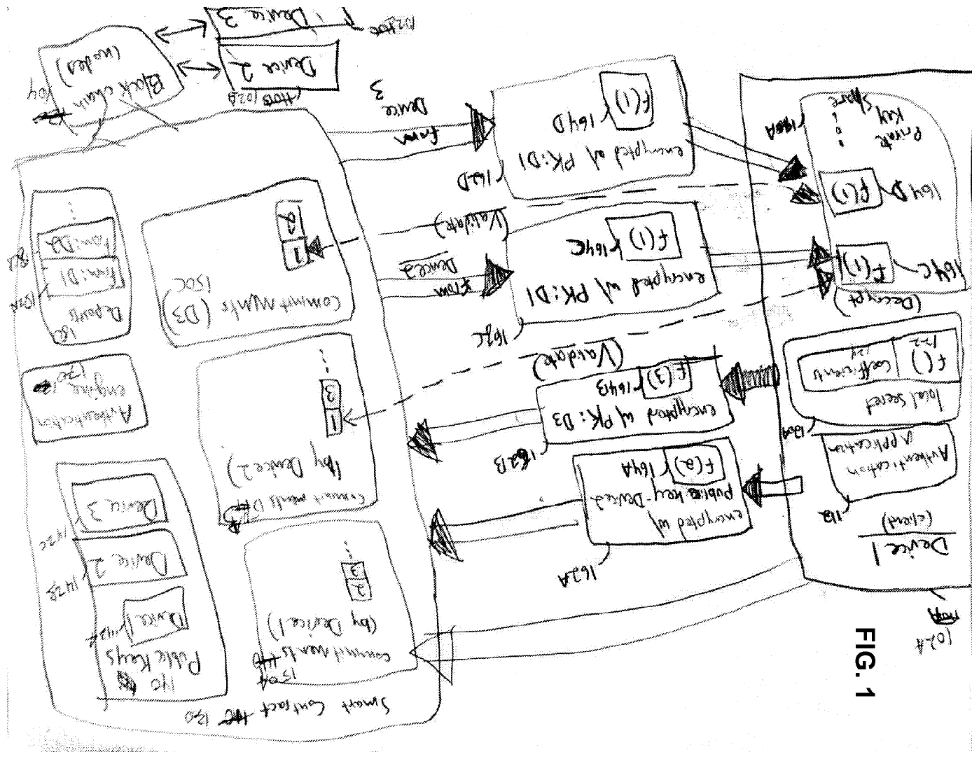

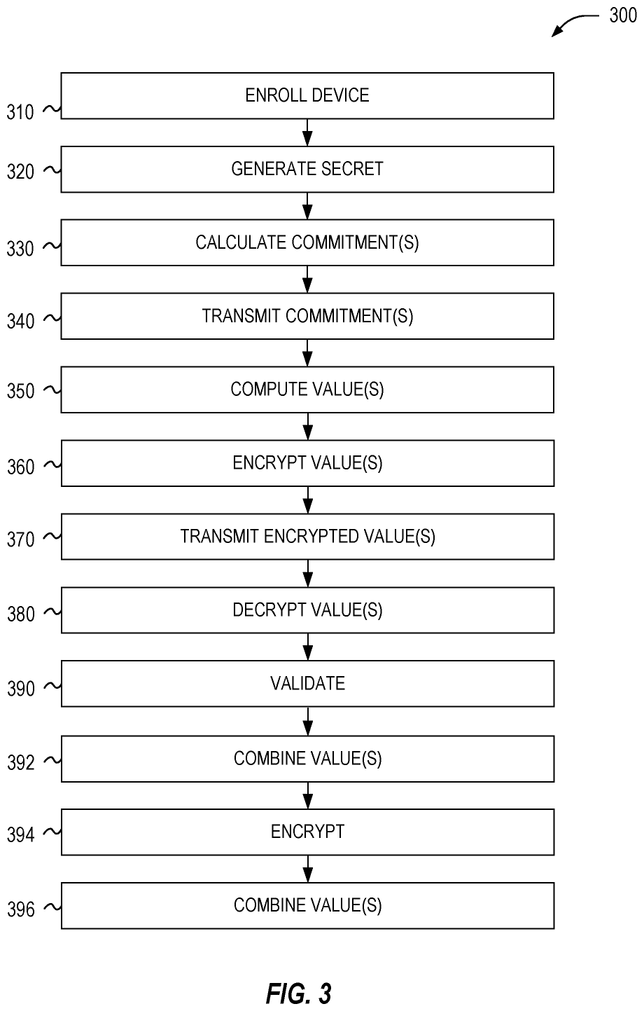

FIG. 3 is a flow chart illustrating a method 300, according to an example embodiment, for decentralized key generation and distribution over a blockchain-based network. The method is performed by processing logic that can comprise hardware (circuitry, dedicated logic, etc.), software (such as is run on a computing device such as those described herein), or a combination of both. In one implementation, the method 300 is performed by one or more elements depicted and/or described in relation to FIG. 1 (including but not limited to device 102A, authentication application 112, network/node(s) 104, and/or authentication engine 170), while in some other implementations, the one or more blocks of FIG. 3 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 310, a device (e.g., a first device) is enrolled. In certain implementations, such enrollment can be enrollment to an application such as a distributed key generation application and/or to a smart contract provided or implemented by such an application (e.g., smart contract 130 as shown in FIG. 1). In certain implementations, such a distributed key generation application can execute across one or more nodes within a decentralized system 104 (e.g., a blockchain, such as the Ethereum blockchain). Moreover, in certain implementations an instruction to transfer, within the decentralized system, a deposit to an address associated with the key generation application can be transmitted. For example, as shown in FIG. 1, ‘Device 1’ can provide an instruction to deposit an amount of Ethereum into the smart contract (which can be stored in the smart contract at 180, as described herein).

At operation 320, a secret, e.g., a local secret is generated. In certain implementations, such a secret 120A can be generated at a first device (e.g., device 102A as shown in FIG. 1) and can include a function such as a polynomial function 122 and one or more coefficient(s) 124, as described herein.

At operation 330, one or more first commitments can be calculated, e.g., for the polynomial function, such as is described in detail herein.

At operation 340, the one or more computed commitments can be transmitted or otherwise provided, e.g., to one or more nodes within a decentralized system/network. For example, as shown in FIG. 1, commitments 150A can be computed by ‘Device 1’ (102A) and provided to smart contract 130 (as executing within network 104). Such commitments can correspond to other devices enrolled with the referenced smart contract, as described herein.

At operation 350, a value of the polynomial function (e.g., function 122 as shown in FIG. 1) can be computed, as described herein In certain implementations, such a value can be computed with respect to an identifying value that corresponds to a second device (e.g., device 102B, as shown in FIG. 1), as described herein.

At operation 360, the computed value of the polynomial function (e.g., as computed at operation 250) can be encrypted. e.g., with a public key associated with the second device. For example, as shown in FIG. 1, the computed value of the polynomial function as computed with respect to an identifying value that corresponds to a second device (164A) can be encrypted (162A) with a public key associated with the second device (142B). By way of further example, as shown in FIG. 1, the computed value of the polynomial function as computed with respect to an identifying value that corresponds to a third device (164B) can be encrypted (162B) with a public key associated with the third device (142C).

At operation 370, the encrypted value of the polynomial function (e.g., as encrypted at operation 360) can be transmitted, e.g., to one or more nodes within the decentralized system, such as is depicted in FIG. 1 and described herein.

At operation 380, an encrypted value of the polynomial function computed by the second device with respect to an identifying value that corresponds to the first device can be decrypted, as described herein. For example, the encryption 162C of value 164C can be received (e.g., from the smart contract/blockchain and originating from ‘Device 2’) and decrypted by device 102A, as described herein.

At operation 390, the device can validate that the decrypted value of the polynomial function computed by the second device (e.g., as decrypted at 380) corresponds to a commitment transmitted by the second device to one or more nodes within the decentralized system. For example, as shown in FIG. 1, ‘Device 1’ can validate that the decrypted value 164C (originating from ‘Device 2’) corresponds to or matches the commitment provided by ‘Device 2’ and stored in the smart contract (e.g., the commitment within commitments 150B, as shown, that corresponds to ‘Device 1’), as described herein.

At operation 392, the value of the polynomial function computed by the second device can be combined with one or more values of the polynomial function computed by one or more other devices to generate a private key share 190A associated with the first device, as shown in FIG. 1 and described herein. For example, values 164C, 164D, etc., can be combined to generate a private key share 190A.

At operation 394, a message or other such content can be encrypted, e.g. with the private key share associated with the first device, such that, when aggregated with one or more messages encrypted with one or more other key shares, signs the message (e.g., using a shared signature aggregation technique).

At operation 396, the value of the commitments computed by the second device can be combined with one or more values of the polynomial function computed by the first device and one or more other devices to generate a master public key and a public key share for the other participating devices, as described in detail herein.

It should be understood that one or more of the operations described with respect to one device can be performed by other devices (e.g., in parallel).

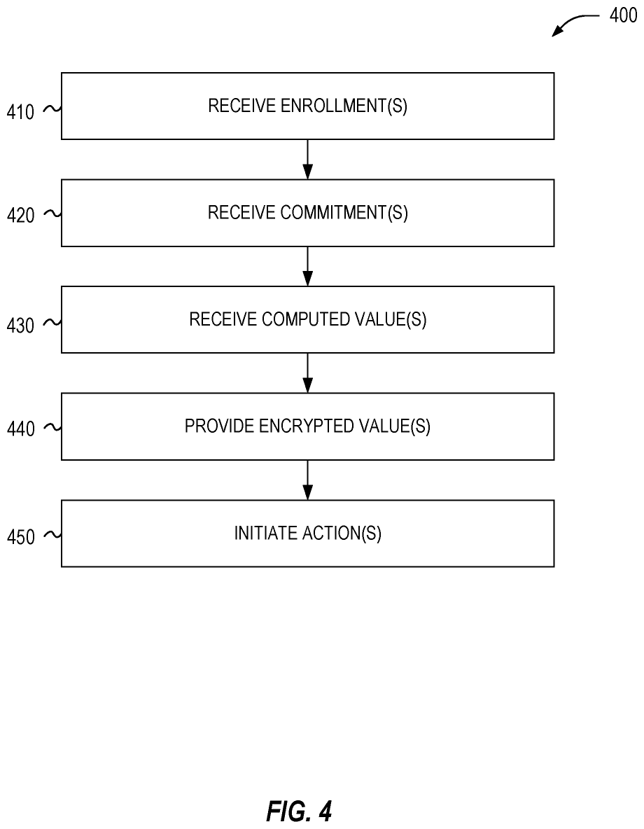

FIG. 4 is a flow chart illustrating a method 400, according to an example embodiment, for decentralized key generation and distribution over a blockchain-based network. The method is performed by processing logic that can comprise hardware (circuitry, dedicated logic, etc.), software (such as is run on a computing device such as those described herein), or a combination of both. In one implementation, the method 400 is performed by one or more elements depicted and/or described in relation to FIG. 1 (including but not limited to network/node(s) 104, smart contract 130, authentication engine 170, device(s) 102, authentication application 112,), while in some other implementations, the one or more blocks of FIG. 4 can be performed by another machine or machines.

At operation 410, receiving an enrollment of a first device, e.g., at a node that executes a distributed key generation application within a decentralized system. For example, smart contract 130 can receive enrollment of ‘Device 1’ as shown in FIG. 1 and described herein.

At operation 420, one or more first commitments computed with respect to a polynomial function in relation to one or more other devices enrolled to the key generation application can be received, e.g., receiving, from the first device. For example, ‘Device 1’ can provide commitments 150A which can be stored in the smart contract, as shown in FIG. 1 and described herein.

At operation 430, a value of the polynomial function computed with respect to an identifying value that corresponds to a second device and encrypted with a public key associated with the second device, can be received, e.g., from the first device, as described herein. For example, ‘Device 1’ can provide such an encrypted value 162A, as depicted in FIG. 1 and described herein.

At operation 440, the encrypted value can be provided to the second device (e.g., ‘Device 2’), as described herein.

At operation 450, one or more actions can be initiated, e.g., based on a verification output provided by the second device, as described herein.

For example, as described herein, based on a determination by the second device that the polynomial function computed by the first device does not correspond to one or more of the first commitments provided by the first device, with respect to an identifying value that corresponds to a second device, an instance of the key generation application can be terminated, a penalty with respect to the first device can be initiated, a penalty with respect to a deposit provided in conjunction with the enrollment of the first device can be initiated, etc., as described in detail herein

A

A

a

a

By way of further illustration, described herein are technologies that enhance threshold cryptosystems by a trusted escrow, e.g., with respect to public blockchains such as Ethereum. As described herein, the described technologies convert a permissioned model that assumes a limited adversary with a permissionless-economic model in which the participants are rational, profit-maximizing entities.

Among the technical challenges associated with such a model for threshold cryptosystems is collusion pressure by colluding, a subgroup of participants can reveal the cryptosystem's secret (which would be translated to unproportional profit).

In certain implementations, the described technologies address the referenced challenges via countermeasure(s) to collusion such as framing. If the trusted escrow is notified of collusion, she rewards the framer from deposits made by the participants. As described herein, under certain circumstances, collusion is equivalent to the prisoner's dilemma, where the colluders' dominant strategy is to frame. Accordingly, collusion is not a rational behavior, thus the secrecy of the cryptosystem is economically guaranteed.

In certain implementations, the described technologies can make sure a secret is secret up to a certain point in time and reveled from a certain point in time (in rational environments). Setting economic constraints on this secrecy. Additionally, as described herein, we define a new model in which threshold cryptosystems could not have existed until now and make the necessary modifications to make them fit the model. The model is different to the previous model in its economic nature and the rational nature of the participants.

Other threshold cryptosystems (secret sharing), such as PoW, VDFs, low influence functions fall short with respect to collusion pressure which turns the random generator useless. The described technologies can be implemented advantageously, for example, as a leader election for lottery or blockchain/consensus applications. In certain implementations, the described technologies build a threshold cryptosystem as a second layer application, e.g., over Ethereum.

One example candidate that can facilitate such an escrow service is the Ethereum blockchain. However, Ethereum is (and should be regarded as) a scarce public resource that is to be used only when absolutely necessary. Ethereum resources: be it forward transactions to the entire network of miners and nodes, process transactions and invoke redundant computation, or have data written to the blockchain, replicated thousands of times.

Threshold cryptosystems can require an initial key distribution step. One approach to decentralized or distributed key generation (“DKG”) for threshold cryptosystems is the Ped-DKG protocol (or Joint-Feldman) which relies on Shamir secret sharing. In certain implementations, the described technologies can utilize on Ped-DKg and adjust it for an economic model.

As described herein, the described technologies provide advantages and improvements including: From a cryptographic perspective, we add hash commitments to handle malleability problem(s) and check group membership of the commitments which is usually omitted. On top of the original DKG protocol, we build an incentive layer that can depend on a trusted escrow that holds the participants' deposits. This allows capabilities including: First, every complaint submitted fails the protocol and invokes slashing. Second, after the DKG and during the time the cryptosystem itself is being used, a framing mechanism is introduced. One motivation behind framing is to discourage or dismantle the collusion pressure that is inherent to many threshold cryptosystems. Most significantly, the framing mechanism allows us to consider an economic model, where value is produced by the cryptosystem and should be handled according to some predetermined notion of fairness (set by the designer of the system).

As also described herein, a specific distributed protocol can be adapted to use Ethereum as an arbitration entity and demonstrate how the distributed protocol itself can be simplified and enhanced by economic incentives. This serves as an example for general purpose layer two solutions.

Second layer interpretation: this can be similar to any second layer protocol. We define a set of complaints (which Ethereum can efficiently arbitrate) and prove they are enough to ensure our threshold cryptosystem satisfies the desired (economic) properties.

Discrete-Log Based Cryptography: Let G=hgi be a cyclic group of order q, and x∈Z_{g} some integer. The discrete-log problem (DLP) in G asks to compute x given the pair (g, g^{x}). Numerous public key cryptosystems are based on the assumption that in certain groups (of efficient representation, and where g^{x} can be efficiently computed given x and g), the DLP is hard, namely that no probabilistic polynomial time Turing machine can solve a random instance of the DLP in G, except for with negligible probability.

Threshold Cryptography: Threshold cryptography refers broadly to techniques for allowing joint groups of parties to use a cryptosystem, be it to compute signatures, or decrypt ciphertexts. In particular, a (t, n)-threshold signature cryptosystem is executed by n participants, where the cooperation of t+1 is necessary in order to sign messages successfully. Threshold security guarantees that any attempt made by up to t of the participants to sign a message is bound to fail.

A threshold cryptosystem can consist of two stages:

1. A key generation executed once to set up a common secret key x corresponding to a public key X, as well as secret key shares x₁, . . . , xₙ held privately by each participant, together with corresponding (public) verification keys X₁, . . . , Xₙ.

2. An application stage, where the key shares may be jointly used over and over in order to sign messages or decrypt data.

Since, in certain implementations, the key shares must be related to one another, the key generation stage must be coordinated and cannot be done independently by each participant.

In the absence of a trusted coordinator, Distributed Key Generation (DKG) protocols allow a set of n participants to jointly distribute key shares, without having any entity be familiar with the secret key x at any point in time.

Cryptographic hash functions and Merkle trees: We overview cryptographic primitives and data structures that we make use of in the described protocol.

Cryptographic Hash Functions: As described herein, we assume the hash functions used are second preimage resistant. A hash function H is second preimage resistant if it is hard to find for a given m i a preimage m₂ 6=m₁ such that H(m₁)=H(m₂). We denote by L the length in bits of the hash value. Due to the second preimage resistant, publishing the cryptographic hash of a value, can be used as a commitment for a value without reviling the actual value in use.

Merkle Tree: A Merkle tree is a tool in cryptography which enables proving a membership of a data element in a set efficiently, without revealing the entire set. In a Merkle tree, every node has a Merkle label. For the leaves this label is the hash of a data block, and for every non leaf node this label is the hash of the concatenation of the labels of its children (or the label of its child in case it only has one child). In order to verify that some data is included in a Merkle tree T, one can obtain from a trusted source the label of the Merkle root of the tree, which we denote by M(T). A Merkle proof for the containment of some data v, which corresponds to a leaf in the tree, consists of the sibling path of the leaf, which contains the labels of all the siblings of the nodes from the leaf to the root. Using these labels, the verifier can compute the label of the Merkle root and check that it is indeed equal to M(T). We assume the Merkle trees used herein are second preimage resistant. This means that given a data set it may be impossible to find a different data set such that the Merkle trees of the two sets have the same Merkle root label.

Ethereum. The Ethereum blockchain, sometimes referred to as a “global computer”, is a public blockchain in the Proof-of-Work (PoW) paradigm that maintains a global state under consensus. State changes are invoked via digital transactions, issued by users, and collected in blocks which in turn are included to the blockchain periodically (through mining). Smart contracts are arbitrary programs, written by application designers and compiled to Ethereum virtual machine, the EVM, which is Turing complete. A Smart contract has specific memory allocated to it and can maintain it arbitrarily. Since anyone can theoretically issue a transaction that invokes any smart contract (which is to be interpreted as a process in an OS) at any time, “global computer” seems a rather appropriate name. However, since Ethereum is a public resource of limited capacity, and due to the high usage (Gas) cost, it can be advantageous to minimize its use.

Capabilities of Ethereum include: Ethereum as a trusted escrow that can follow a complex set of rules, and Ethereum as a public broadcast channel.

Ethereum as escrow: A smart contract over Ethereum can easily realize an escrow service its state determines a set of users with a specific balance and it follows a specific logic which determines when and how these balances should be released back to the users. A sophisticated escrow service can incentivize rational users to act according to some predetermined notion of correct or desired behavior.

Communication over Ethereum: The Ethereum blockchain may serve as a tamper-resistant, publicly-available and censorship-resistant “blackboard”. Tamper-resistance means that once a record has been included in the blockchain (sufficiently long ago), subverting it is practically impossible. Public-availability guarantees anyone has read permissions from the blockchain Finally, censorship resistance means that for a reasonable fee anyone can write arbitrary data (of reasonable size) to the Ethereum blackboard within an expected delay (that depends on the fee paid and counted in blocks). These three qualities make Ethereum a great synchronous broadcast communication channel. Specifically, we model Ethereum such that it takes at most δ blocks to get a transaction in a block. Additionally, by using public-key encryption (e.g., El Gamal encryption), Ethereum can be used as a private communication channel between any two entities.

GJKR/Pedersen DKG: In this section we outline the GJKR-DKG protocol for discrete-log based threshold cryptosystems.

Model: The protocol is assumed to run among a set of n (known) participants P₁, . . . , Pₙ, which can be modeled by probabilistic polynomial time Turing machines. We also assume the existence of an adversary that can corrupt up to t of the players and instruct their behavior.

Communication: Communication in the protocol is assumed to be synchronous, that is, a message is delivered from source to destination within some known and fixed time bound. The participants use both private and public communication. For private communication, ‘a complete network of private (i.e., untappable) and authenticated point to point channels’ is assumed to allow any two participants to communicate privately. By referring to communication as public, it is understood that the data received is consistent among all participants. In particular, every participant should be convinced that the data they received via the public broadcast channel matches the data received by others.

Adversary: The adversary A can corrupt up to t<n/2 participants. A is static in the sense that it chooses the participants it corrupts at the beginning of the protocol. The adversary may not have additional computational capacity over that of the participants it corrupted. Corrupted participants may act arbitrarily and might have one of many goals, e.g., fail the protocol or gain information on secrets.

Protocol Description: Recall that, non strictly, the goal of a (t, n)-DKG protocol is twofold generate a global secret key (keeping it secret from any entity), and distribute key shares that jointly correspond to the global secret. Any t+1 key shares can reconstruct the global secret, but t (or less) key shares cannot extract any useful information.

These goals are easy to achieve if a trusted dealer is present. In the spirit of Shamir secret sharing, the dealer would generate a degree t polynomial f, and share with P, her secret key share f(i). Then, the reconstruction could be done using Lagrange interpolation, where the global secret is f(0). Feldman showed how this procedure could be made verifiable, allowing the participants to verify the validity of their key shares.

Pedersen designed a DKG protocol achieving the above goals without a trusted dealer. His protocol, Ped-DKG, consists of n parallel Feldman VSS runs, each led by participant a Pᵢ sharing a “local” polynomial fᵢ. The global polynomial f is defined to be the sum of the local polynomial.

The protocol can rely on the fact that the sum is taken only on those polynomials which were shared correctly, which is crucial to the success of the protocol. This set is referred to as the set QUAL of “qualified” polynomials.

Gennaro et al. point out a last actor attack in Ped-DKG, giving the adversary some control over the composition of the set QUAL. This problem can be mitigated using an additional communication round to construct QUAL properly, and it can be proven that under relaxed (yet practical) requirements, the original Ped-DKG is sufficient.

Protocol Properties: Defining the requirements from a DKG protocol is not a trivial task. A minimal set of requirements can be formulated for a (t, n)-DKG protocol in Discrete-Log based cryptosystems.

Correctness: (C1) There is an efficient procedure that on input any t+1 (different) secret key shares produced by the protocol, outputs the same secret x. There is another efficient procedure that on input n secret key shares (of which at least t+1 were produced by the protocol) and the public data produced by the protocol, outputs the unique global secret x.

(C2) There is an efficient procedure that on input the public data produced by the protocol, outputs g^{x}, where x is the unique secret key guaranteed by (C1).

(C3) x is uniformly distributed in Z_{q}, hence g^{x} is uniformly distributed in G.

Secrecy: No information on x can be learned by the adversary except for what is implied by the value g^{x}. A more formal description of the secrecy property involves a simulator which mimics the output of the DKG protocol based on g^{x} alone.

Various protocols, such as those described herein, can achieve properties (C1), (C2). Various attacks can be shown to compromise (C3), which also breaks the standard proof of the secrecy property. Protocol(s) presented herein share certain similarities to the Ped-DKG, but we solve the above attack using hash commitments.

While theoretically Joint-Feldman DKG provides correct and secret keys, it suffers a few practical drawbacks. We discuss these briefly, alluding to our modifications and improvements.

Adversarial model: Lacking an adversary, a DGK protocol can be made trivial. The complications appear when the protocol should admit certain properties when an adversary does exist. Assuming an adversary implies there is something to gain from interrupting with the protocol. The Joint-Feldman approach lacks a clear notion of this “gain”. However, in order to have a functioning system, the adversary must be limited the protocol relies on the adversary corrupting at most t players. Quite ironically, an adversary controlling t players is unlikely to stop there as she is highly motivated to corrupt the t+1 player and get control of the underlying cryptosystem.

Among the element that enable us to define an economical model is a trusted, publicly available escrow service that can enforce a general set of rules—e.g., the Ethereum blockchain.

Complaints and the set QUAL: The complaint mechanism in Ped-DKG relies on the fact that a player can reveal up to t of her sub-shares (points on her secret polynomial) without breaking its secrecy. This is of course theoretically true, but weakens the robustness of the protocol. Imagine a situation where player P, has revealed t of her sub-shares (due to t complaints against her). Without loss of generality, be those fᵢ(1), . . . , fᵢ(t). Now, in order to break the secrecy off, it suffices to hack any of the players that did not complain, i.e., P_{y+1}, . . . , Pₙ. This is a much easier task then having to hack specifically Pᵢ.

Another issue is that more than t participants can coordinate their complaints to exclude other participants from the set QUAL. This opens the opportunity to influence the secret (or the polynomial f) and may serve as further motivation to get control of t+1 players over the general motivation of acquiring “full rights” in the underlying cryptosystem.

Public broadcast channel: implementing a reliable broadcast channel is a considerable challenge. The difficulty boils down to the fact that reliable broadcast amounts to reaching consensus in an adversarial environment. Consensus protocols are quite complicated they introduce the need for participant authentication (e.g., MACs or digital signatures), require extra communication rounds, do not scale well in the number of participants, and in asynchronous networks restrict the bound on the faulty participants to t<n/3. As discussed herein, public blockchains, and specifically Ethereum, emerge as reliable broadcast mediums that admit the needs of a DKG protocol in the spirit of Joint-Feldman.

Described herein is our variant of the original Ped-DKG protocol. Our economic driven approach stands during the DKG protocol, but also afterwards when the threshold cryptosystem itself is being used. Thus, we regard the DKG and the underlying threshold cryptosystem as one complete system.

Rational threshold cryptosystems: In this section we described various implementations for threshold cryptosystems that admit correctness, secrecy and robustness in rational environments. Our framework relates to the entire lifetime of the cryptosystem from key generation to application. The key generation kick-starts the system by distributing correct keys to the participants. These are later used within some desired application, in which secrecy and robustness are to be maintained. Also described is a DKG protocol based on Ped-DKG and the concept of framing to maintain secrecy and robustness during the course of the application.

Our framework can include a trusted escrow that can follow predetermined logic and execute general computations. The Ethereum blockchain is an example candidate for such escrow services. Ethereum however is to be regarded as a scarce compute resource that should be used carefully. Cryptosystems can invoke costly computations that cannot be executed naively over Ethereum. While many techniques allow for reducing the amount of interaction with Ethereum, in this section we avoid Ethereum specific optimizations and focus on the economic perspective of our protocol. In a sense, we assume “an ideal Ethereum” whose execution costs and limitations resemble that of a standard computer. Also discussed herein are various Ethereum-specific optimizations.

Model: In one example model, a set of n participants P₁, . . . , Pₙ take part in the cryptosystem. Note the distinction between participants and entities—different entities have independent utility functions, but different participants may correspond to the same entity. One possible approach to model permissioned participation is to assume that the participants correspond to different entities. Our participation model is permissionless under this notion.

The referenced model can be enhanced with a trusted and transparent escrow service that can take deposits and slash participants according to some predetermined logic—the Ethereum blockchain. Moreover, Ethereum can be used as a public broadcast channel (as required by Ped-DKG).

Finally, hard constraints need not be imposed on the ratio between t and n—different ratios reflect different trade-offs that can be made.

Economic adversarial model: The network over which a threshold cryptosystem takes place may consist of mutually trusting entities. Then, the designer can assume all participants follow the protocol's instructions. The adversary is seen as an external entity that gains control of the participants and corrupts them. The protocol's “success” or ability to satisfy its requirements depends on the strength of the adversary. Another viable environment is one composed of distrusting entities. Then, we cannot expect the participants to follow some predetermined set of rules, but must assume they are driven to maximize their own profits.

To formulate our economic model we assume a threshold cryptosystem produces some total value R. By participating, the default or intended utility of a participant is ^{αR}ₙ for some 0≤a≤1, in expectancy. The remains go to external entities we refer to as “the public”. Controlling t+1 (or more) participants can be translated to unproportional utility gains. In the worst case the coalition takes the whole value R.

The referenced model strongly captures the intuitive notion of collusion pressure. In a threshold cryptosystem the participants are incentivized to form a coalition of t+1 and increase their utility. The cryptosystem now needs to dismantle this pressure.

Design rationale: Thinking of threshold cryptosystems under such an economic model can require different terminology—participants are not “honest” or “corrupted”, they are rational. The designer of the system can no longer assume a majority of “honest” participants and must align the participants' preferred strategy with the system's intended behavior. Conversely, the trusted escrow service we assume follows specific logic, determined by the designer of the system, without deviations. Potential participants are made aware of this logic and choose whether to join or not. Concretely, the escrow can be realized by a smart contract over Ethereum.

In certain implementations, participation in the cryptosystem can be conditioned on a deposit made to the escrow. For example, we interpret a threshold cryptosystem as an investment channel in which participants invest an initial sum of money, and hope for a return on their investment. As in any investment channel, a risk aspect is inevitable.

The referenced escrow can decide to slash deposits in case complaints or framings are filed. The complaint mechanism can be composed of four elements:

1. Claim. A participant claims to have detected a deviation from the intended evolution of the protocol.

2. Proof. She supplies the smart contract with a proof for her claim.

3. Arbitration. The smart contract verifies the claim by the proof.

4. Incentive layer. The smart contract redistributes the deposits (slashing and rewarding participants) according to a predetermined set of rules.

A complaint mechanism is measured by its ability to support detection and efficient arbitration (over Ethereum) of as many unintended behaviors as possible. Moreover, in certain implementations the incentive layer must make complaining profitable. Then, evidently, participants would be discouraged from acting in ways that enable complaints against them in the first place.

Complaints may have additional consequences atop redistributing and burning deposits. In the original Ped-DKG protocol complaints result in revealing secret sub-shares or excluding participants from the set QUAL, but under their assumed adversarial model, the DKG procedure never fails. We make two clear distinctions first, we consider failure (during the DKG procedure, relaunching with an updated set of participants is easy; during the application stage relaunching is much more complicated); second, if the DKG procedure succeeds, no participant is excluded. Failing the system should be regarded as any other strategy—a participant would choose to fail the protocol only if it maximizes her utility.

The Achilles' heel of a threshold cryptosystem is the possibility of its participants to collude when they should not do so.

Definition 1 (Collusion: Collusion is any information sharing between a subset of t+1 (or more) participants, representing different entities, that is done under undesirable circumstances. We assume though that a collusion leaves a trace.

A threshold cryptosystem can require the cooperation of its participants. However, there might be undesired ways in which the participants might cooperate. One intuitive example could be that a certain threshold signature should not be produced prior to some predetermined Ethereum block height. If t+1 participants were to collude and generate that signature prior to the target time, this would be regarded as collusion Our complaint mechanism addresses this problem and provides an effective countermeasure against collusion.

Protocol description in certain implementations, the protocol can be run by a client software that interacts with a smart contract over Ethereum. Participants enroll to the protocol with their Ethereum address and from that point on are associated with that address. Eth-DKG proceeds in phases, which roughly correspond to Ped-DKG. Each phase begins when the previous one ends and lasts at most δ Ethereum blocks (recall the parameter δ). During each phase, the participants can be asked to perform some computation and share information privately or publicly. When they detect unintended behavior they have the opportunity to gain an immediate profit by complaining. In case of a complaint, the smart contract executes the necessary computations and rules whether the complaint was justified or not, rewarding the correct participant from the deposits of other ones.

There are numerous differences between the described technologies and the Ped-DKG. First, while we make the distinction between the DKG step and the cryptosystem step, the smart contract with the participants' deposits keep living after the DKG and complaints (or framings) are still possible. These should correspond the specific use-case of the cryptosystem. Second, in Eth-DKG, complaints may result in failing the protocol—during the DKG step the protocol would be reinstantiated easily; during the cryptosystem step though, human intervention would be needed in order to re-instantiate the system, and failing is regarded as a doomsday scenario. Third, a rather technical difference is the use of hash commitments in the enrollment phase which solves the last actor problem (without much overhead as enrollment is needed).

We note that for clarity of presentation the protocol is divided into phases according to their role within the protocol. In practice, there may be less phases.

Once the DKG step/operation has terminated successfully, every participant Pᵢ locally calculates her secret key share xᵢ, the verification keys of all participants Vⱼ, and the public key of the scheme X₀. Where,

$${x}_{i} := f ( i ) = {\sum }_{j = 1}^{n} {x}_{j , i} = {\sum }_{j = 1}^{n} {f}_{i} ( i )$$

$${V}_{j} := {g}^{f ( j )} = {\prod }_{i = 1}^{n} \text{?}$$

$${X}_{0} := {g}^{f ( 0 )} = {\prod }_{i = 1}^{n} {X}_{i , 0} = {\prod }_{i = 1}^{n} {g}^{{f}_{i} ( 0 )}$$

$$\text{?} \text{indicates text missing or illegible when filed}$$

Fig. X: Escrow-DKG

0 Deployment. The protocol formally begins when the smart contract is deployed. Any Ethereum account can deploy the contract.

1 Enrollment. The relevant Ethereum accounts enroll to the protocol by submitting an enrollment transaction. We refer to the participants by their enrollment order 1≤i≤n. To enroll, participant Pᵢ locally generates:

(a) A random polynomial of degree t over Z_{q},

fᵢ(z)=aᵢ₀+a_{i,1}z+ . . . +a_{i,t}z^{t}

(b) A private key for private communication over Ethereum, ξᵢ\ddot{∈}Z_{q}

(c) Commitments to fᵢ's coefficients, X_{i,k}=\ddot{ }g^{a}^{_{i,k}} for k∈{0, . . . , t}

She then submits her enrollment transaction

tx₁(a)=[Δ,Γᵢ,H(X_{i,0})]

where Δ is her deposit in Eth, Γᵢ=\ddot{ }γ^{ξ}^{ᵢ} is her public encryption key and H(X_{i,0}) is her hash commitment to her partial secret a_{i,0}.
(The notation=\ddot{ } means “should equal”. When a value is sent from Pᵢ and Pⱼ we would like to indicate what that value should be, but of course Pᵢ is an independent entity and can send another value if she finds it more profitable.)

(In order to keep the presentation concise, we omit technical complaints: group membership of Γᵢ or the commitments X_{i,k}, and valid ciphertext ENC.)

2 Commitments. Every participant Pᵢ submits a commitments transaction,

tx₂(i)=[{X_{i,k}}ₖ₌₀^{t}]

If Pᵢ fails to submit tx₂(i) in time, any Ethereum address C can file a complaint, cm₁(C, i), against her. If X_{i,0} given in tx₂(i) does not match its hash commitment from tx₁(i), any Ethereum address C can file a complaint cm₂(C, i).

3 Sub-shares. Every participant P locally computes her sub-shares x_{i,j}=\ddot{ }fᵢ(j) for all j. For 6=i she encrypts x_{i,j} using Pⱼ's public encryption key and submits the corresponding sub-share transactions

tx₃(i,j)=[ENCx_{i,j}Γⱼ]

If Pᵢ fails to submit tx₃(i, j) in time, any Ethereum address C can file a complaint, cm₃(C, i, j) against her.

4 Sub-shares Verification Every participant Pⱼ locally verifies the sub-shares destined to her are consistent with the public commitments. That is, she checks that for all i

$$\text{?} = {\prod }_{k = 0}^{t} ( \text{?} \\ \text{?} \text{indicates text missing or illegible when filed}$$

If the equality for some i′ does not hold, Pⱼ can file a sub-share complaint, cm₄(j, i′, ξⱼ) against P_{i′}.

If no complaints were filed during the course of the protocol, the Eth-DKG is said to have completed successfully (and the deposits are kept for the application stage). Otherwise the complaint is arbitrated and the protocol is relaunched accordingly.

Application Once the DKG step/operation has terminated, the participants can begin using their key shares, be it to produce threshold signatures or co-decrypt ciphertexts. If required by the cryptosystem (as would often be), any public information generated by the DKG can be written over Ethereum. For example, any participant can send a public key transaction tx₄=[X₀] (which would be subject to complaining of course).

As mentioned previously, the smart contract is not killed though—it can keep escrowing the deposits and enforcing a use-case specific complaint mechanism. One of the smart contract's goal(s) during the cryptosystem step is to discourage collusion Thus, as part of the complaint mechanism we introduce framing transactions. At any point in time, (also during the DKG step), any entity can submit to Ethereum: fin(id, data), which is to be read as follows—Ethereum address id₁ frames a collusion that the smart contract can confirm using data.

Complaint and Framing Mechanism: A general complaint (or framing) constitutes of four parts: claim, proof, arbitration and incentive layer. Table(s) incorporated herein describe various complaints (including framing) explicitly with respect to these four aspects. For each complaint the table depicts its notation, the claim it makes, the data required to prove the claim, how the arbitration is done, and finally what are the results of the complaint in terms of incentives—who is slashed and who is rewarded, and by how much.

TABLE 1
Complaint and Fram [symbol] Mecha

[symbol]

| Title | Claim | Proof data | Arbitration | Incentives |
|---|---|---|---|---|
| [symbol] | [symbol] did not [symbol] | Id of [symbol] | Check [symbol] contract [symbol] [symbol] | $\begin{matrix}\begin{matrix}\begin{matrix}P \text{?} : - Δ \\ P \text{?} + \frac{Δ}{\text{?}} for all \text{?} \neq \text{?}\end{matrix} \\ P \text{?} - Δ\end{matrix} \\ P \text{?} + \frac{Δ}{\text{?}} for all \text{?}\end{matrix}$ |
| [symbol] | Hash [symbol] [symbol] | Id of [symbol] | Get X [symbol] from [symbol] and compute [symbol] . Compare with value in [symbol] | $\begin{matrix}\begin{matrix}\begin{matrix}P \text{?} : - Δ \\ P \text{?} + \frac{Δ}{\text{?}} for all \text{?} \neq \text{?}\end{matrix} \\ P \text{?} - Δ\end{matrix} \\ P \text{?} + \frac{Δ}{\text{?}} for all \text{?}\end{matrix}$ |
| [symbol] | [symbol] did not [symbol] [symbol] | Id of [symbol] index [symbol] | Check smart contract storage. | $\begin{matrix}\begin{matrix}\begin{matrix}P \text{?} : - Δ \\ P \text{?} + \frac{Δ}{\text{?}} for all \text{?} \neq \text{?}\end{matrix} \\ P \text{?} - Δ\end{matrix} \\ P \text{?} + \frac{Δ}{\text{?}} for all \text{?}\end{matrix}$ |
| [symbol] | [symbol] submitted [symbol] sub- [symbol] | Id of [symbol] [symbol] | Decrypt [symbol] using [symbol] and compute [symbol] Compute [symbol] using data from [symbol] Compare. | $\begin{matrix}\begin{matrix}\begin{matrix}P \text{?} - Δ \\ P \text{?} + \frac{Δ}{\text{?}} The other \frac{Δ}{\text{?}} \text{?} .\end{matrix} \\ P \text{?} - Δ\end{matrix} \\ P \text{?} + \frac{Δ}{\text{?}} for all \text{?}\end{matrix}$ |
| [symbol] | Pᵢ submitted in- correct public data [symbol] (e.g. [symbol] public key share of) | Id of [symbol] | Get data from storage (com- mitments {X [symbol] . Com- pute desired value [symbol] and compare with [symbol] . | $\begin{matrix}\begin{matrix}\begin{matrix}P \text{?} : - Δ \\ P \text{?} + \frac{Δ}{\text{?}} for all \text{?} \neq \text{?}\end{matrix} \\ P \text{?} - Δ\end{matrix} \\ P \text{?} + \frac{Δ}{\text{?}} for all \text{?}\end{matrix}$ |
| [symbol] | [symbol] holds [symbol] evi- dence (e.g., C knows the secret [symbol] ) | evidence y | Get relevant data from storage. Compute desired value, and compare with [symbol] | $\begin{matrix}\begin{matrix}\begin{matrix}{p}_{j} \div \text{?} Δ \\ All other money burnt .\end{matrix} \\ P \text{?} - Δ\end{matrix} \\ P \text{?} + \frac{Δ}{\text{?}} for all \text{?}\end{matrix}$ |

[symbol]

indicates data missing or illegible when filed

One goal of complaints is to make sure that the sub-shares participants communicate match the commitments they publish (cm₅ in phase 4). The rest of the complaints deal with technical concerns arising from implementing the protocol in practice.

Complaints are straightforward and can have two sides—the accuser and the accused. In some cases, the smart contract can rule the complaint based only on its storage. For example, this is the case with “missing data” complaints (cm₂, cm₄). (Note that in the “optimized” version, this type of complaints becomes more complicated as Ethereum cannot determine whether information was exchanged off-chain).

There are many optimizations that can be made to deal with this that are Ethereum specific.) Other complaints require the smart contract to run some computation and include any piece of data required. For example, cm₅, in which the decryption key ξⱼ is submitted so the smart contract could access ENC(x_{i,j}, Γⱼ)).

One goal of framings is to prevent the profitability of collusion Framing include the “framer” and a piece of information that should prove collusion has indeed taken place.

Properties: The protocol satisfies three properties that we discuss hereafter. Fundamentally, the original requirements of a DKG protocol presented herein can be adapted to our economic model and we prove them under the assumption that the entities are rational.

Lemma 1 (Communication). The public and private communication schemes we use over Ethereum satisfy the requirements described herein.

Proof private: public key encryption works. public: From the assumptions on Ethereum.

Correctness: Claim (Correctness). If Escrow-DKG (i.e., only the DKG stage) completed successfully, then the secret key shares and the public data produced by the protocol admit (C1) and (C2). If an additional at least one participant Pᵢ has reliably sampled her partial secret a_{i,0} uniformly in random then (C3) is also satisfied.

Lemma 2. If Escrow-DKG completed successfully then no entity could have made a valid complaint against another entity.

Proof We prove that if an entity had the chance to file a complaint against another entity, she would have done so. This might seem trivial as filing a justifies complaint yields an immediate profit to the challenger. However, since complaints require relaunching the DKG stage they might reduce the value R (e.g., due to loss of credibility).

We show that even if the R reduces to 0 due to a filed complaint, it is still beneficial to complain when possible. There are three complaint categories to consider.

1. Complaining against private data mismatch (sub-share complaint cm₄). A participant Pⱼ has clear motivation of having a secret key share that matches the public key. If one of her sub-shares fᵢ(j) does not match the commitments she received from Pᵢ, she would end up with a useless secret key share that would not allow her to participate in the protocol. De facto, P, is not a participant and loses her expected profit,

$${}^{\underline{aR}} n .$$

Thus, the immediate reward of Δ/2 suffices for her to complain.

2. Complaining against public data mismatch (cm₂, cm₅). In this case any entity, including external to the protocol, can complain Since external entities have nothing to lose and will gain a profit they will indeed complain Since they know external entities will complain, participants are also incentivized to do so.

3. Complaining against missing data (cm₁ and cm₃). While we do mention these complaints, in practice the escrow service itself can detect missing data. This serves enough of an incentive to complain for the immediate profit.

Proof From the previous lemma we can determine that no entity could have made a justified complaint against another entity during the run of Escrow-DKG. Such a run of Escrow-DKG is equivalent to a Ped-DKG run in which all the participants follow the protocol. The equivalence can be shown as follows. Consider a mapping from the participants in the Escrow-DKG run to those in a Ped-DKG run and assume they sample the same local polynomials fᵢ. Then, if all the Ped-DKG participants are correct, then none complain and the data (public and private) produced by the protocol is identical to that in the Escrow-DKG run. From (C1) and (C2) in Ped-DKG we have them in Escrow-DKG.

Regarding (C3), hashing g^{a}^{_{i,0}} in the enrollment transaction guarantees that when Pⱼ samples a_{j,0} she is unaware of g^{a}^{_{i,0}} (for any i) and cannot relate her partial secret to other ones. Now, since we assume at least one participant samples her partial secret uniformly in random, their sum is also effectively sampled that way.

We remark that any participant that sampled her partial secret correctly is convinced that the secret of the scheme is sampled uniformly in random. An external entity must believe at least one participant has correctly sampled her partial secret. Alternatively, an external entity to be convinced of C3, she must believe that at least one participant correctly sampled her partial secret.

Secrecy: Claim (Economic collusion resistance). of rational threshold cryptosystems (Escrow-DKG and the application afterwards), if

$$\frac{( t - 1 ) Δ}{\underline{2}} > R and a > \frac{n}{\underline{2 ( t - 1 )}}$$

then controlling the system via collusion requires two entities to invest at least

$${}^{\underline{{(}^{t + 1 ) Δ}}} 2$$

each.

Note that if one entity controls t+1 participants (or more) the system is broken, but we do not relate to this as collusion. Furthermore, it follows from the claim that also two entities controlling more than ^{t+1}₂ participants each would break the system. Trusting the system implicitly means that such a scenario is highly unlikely.

In permissioned networks, this is indeed the case—by definition different participants belong to different entities. Alternatively, in a permissionless setting, if t (and n) could be made very large (This is not an easy task as the DKG's complexity is quadratic and requires expensive elliptic curve calculations. One possibility to tackle this problem is to have many similar DKG contracts live side by side, each with say n=100, and inter-connect them in a Dfinity inspired architecture.), then such an assumption becomes reasonable. Enlarging Δ would also help. See the next section, in which we p over Ethereum that can reach n=1000 with reasonable costs. It also reasonable to assume no single entity could gain control of

$${}^{\underline{t + 1}} 2$$

participants.

Enlarging Δ would further strengthen this assumption.

Proof Consider the case of two separate entities A and B with a and b DKG participants respectively. Assume a+b=t+1≥such that if the two entities collude they control the system. It is enough to show that for such a collusion.

to be profitable, A and B would each have to invest (at least)

$${}^{{ }^{\underline{( t + 1 ) Δ}}} 2.$$

We analyze the payoff matrix of A and B after a collusion has taken place. A's two options are either to frame or not to, and vice versa.

Entity B

| | Frame | Not frame |
|---|---|---|
| Frame | A utility: | A utility: |
| Entity A | B utility: | B utility: |
| Not frame | A utility: | A utility: |
| | B utility: | B utility: |

In case B chose to frame, then obviously A is better off framing as well (whoever gets her complaint transaction processed first wins while the other loses all her investment). Otherwise, in case B does not frame, A's utility can either be (t−a)Δ (by framing), or R·ₜ^{a}+1 (by not framing). In case a≤t+1 2, she is better off framing. B's view is the same as A, which means only if a and b both are at least

$${\underline{t + 1}}_{2}$$

no framing would occur.

If

$$a < {}^{\underline{t + 1}} 2$$

then B would disagree to collude with A, even though her most profitable outcome would be to collude with A and make sure nobody frames. Since B knows A's dominant strategy is to frame it is not rational of her to collude with A. For A to convince B she will not frame, her payoff matrix must change either her potential profit from framing reduces, or her profit from a successful collusion increases.

In the first case, she would have to convince B of additional loss Δ_{A} in case she frames. Her total investment would then be aΔ+Δ_{A} and to be discouraged from framing, this needs to be larger than l_{A}:=tΔ−Ra/(t+1). A simple arithmetic calculation then shows that A's investment would have to be larger then

$$\frac{( 3 t - 1 ) Δ}{\underline{4}}$$

after substituting R with

$$\frac{( t - 1 ) Δ}{\underline{2}} ) .$$

Since this is higher than

$${\underline{( t + 1 ) Δ}}_{2} ,$$

we conclude that collusion is profitable only if both sides invested more than ^{(t+1)Δ}₂.

Alternatively, in the second case, B would have to convince A of additional profit if the collusion succeeds. B could only offer her marginal profit from the collusion (relative to not colluding), which is Rb

$$( \frac{1}{t + 1} - \frac{\text{?}}{\text{?}} ) . \\ \text{?} \text{indicates text missing or illegible when filed}$$

This sum would have to be bigger then (t−a)Δ. Under the assumptions that a+b=t+1 and α>n/2(tn−1) this does not hold and thus B cannot “buy” A's cooperation.

The relationship between Δ, R, α and t/n can be tuned differently. Specifically, maybe R should be smaller relative to Δ and then α can be made smaller also.

Note that the more participants an entity controls the less she is encouraged to frame. Thus, a collusion between a large entity and a small entity is less probable—the smaller entity would frame the larger one. A collusion between two entities of the same size is the interesting case. Considering the case of a single entity with t participants is easier.

As a by product, we see from the proof that if

$$a < {\underline{( t + 1 )}}_{2} ,$$

then Δ_{A} would have to be such that

$${Δ}_{A} + a Δ > {\underline{( t + 1 ) Δ}}_{2} .$$

In total, A must invest more than

$${\underline{( t + 1 ) Δ}}_{2}$$

n order to convince B to collude with her. However, her additional investment Δ_{A} does not yield additional profit—A is better off investing the money in more DKG participants. The main conclusion from this is that A's best strategy is to invest directly in the DKG and not in side contracts.

What if she tried to get t+1 DKG participants and failed?

In practice, R might be hard to asses, take long to obtain, and bare significant risks. Thus, we believe that in a real system, if Δ is large enough (regardless of R), it would serve as a sufficient incentive to frame and prevent collusion.

Remark “small collusion”. If the system was to allow framing Pⱼ by reveling data that should be known only to her (e.g., f(j)), it may serve as means to discourage small collusions (These could be motivated for reasons as in Bitcoin, reducing the variance in the reward distribution). However, this would increase the risk for honest participants—an entity controlling the cryptosystem could frame anyone she wanted and have them lose money for no reason. The option of not enabling framing small collusions may be the better option if what we really care about are the big collusions. Any small entity would be highly motivated to frame a “big collusion” if that ever was to be reached (as was shown in the proof). “small collusions” (pools) are not necessarily bad if the different entities within the coalition keep having individual interests.

Corollary 1. In the setting of claim, if no entity has invested

$${\underline{( t + 1 ) Δ}}_{2}$$

then Escrow-DKG is secret.

Proof. If no entity has invested

$${\underline{( t + 1 ) Δ}}_{2}$$

then no two entities could be found to collude and obtain t+1 secret key shares. If smaller entities were to collude forming a more-than-two-entity collusion, obtaining t+1 secret key shares, any entity within that collusion could view the payoff matrix as herself against the other entities, united. It would thus be profitable for any entity within that collusion to frame. We can thus conclude that no more-than-two-entity collusion would emerge. This concludes that secrecy is kept.

Robustness: If collusion resistance mitigates the risk of revealing the secret prior to some predetermined time, robustness deals with the possibility of not revealing the secret after that time.

There are two places where the protocol can fail—during Escrow-DKG or during the application In the first, it is not very interesting as if the system is not broken (i.e., one entity controlling t+1 participants or collusion) then no one has motivation to fail the protocol, as it is immediately relaunched. If the system is broken, the entity (or entities) with control are assumed to take the total value within the system R. It is still important to have a price for failing the protocol in order to avoid unnecessary slowdowns (or DDoS). Quite trivially, the price of failing Escrow-DKG (during the DKG step) is Δ/2—any complaint that fails Escrow-DKG results in at least Δ/2 Eth burnt.

Robustness during the application step is more interesting and can be defined as follows. The cryptosystem is robust if the secret is submitted to the escrow within a specific and predetermined time interval. A conservative assumption could be that only if all participants find out the secret, then it would be delivered to the trusted escrow to distribute the reward R. To make sure indeed all participants find out the secret we can use a protocol such as those described herein. Alternatively, in certain implementations we can define robustness economically by estimating the price of preventing the secret from getting to the escrow.

One option to obtain economic robustness is to instruct the escrow to burn all deposits after the time interval has passed. As preventing the escrow from getting the secret implies n−t participants refuse to reveal their share, this would cost (n−t)Δ. Note that even though participants expect a reward of ^{αR}ₙ) from participating correctly in the cryptosystem, due to variance in the reward allocation, we must assume the worst case scenario where only one participant gets the whole αR. She would obviously be the sole participant with motivation to submit the secret.

As a participant in the system, risk of being slashed due an unrelated collusion framing should be estimated—equivalent to the Bitcoin analogy, buying ASICs that become useless if Bitcoin is 51% attacked.

Various example implementations are further illustrated herein.

In this section we demonstrate how the framework we proposed can be applied to the classic problem of generating non-manipulable randomness in a decentralized environment. Escrow-DKG can be used to initialize a (t, n)-threshold BLS-3 signature scheme, which is then used to produce unique signatures over specific values in specific target times. We use Ethereum as the escrow service for our application. As mentioned earlier, this requires modifications to various protocol(s) such as those described herein We first elaborate on the Ethereum specific modifications and then describe the randomness beacon We further illustrate the protocol, Eth-DKG in detail herein.

Ethereum related concerns—The necessary data for arbitrating complaints may be too costly to write over the storage of an Ethereum smart contract. Simple elliptic curve computations (that are necessary to verify sub-shares, for example) may be practically unfeasible to run over Ethereum, even when n and t are small. The described Ethereum implementation can be configured in relation to the following principles.

Optimistic off-chain approach: The general method to circumvent the consumption of on-chain resources is to follow an optimistic off-chain approach—all data transfer (apart for enrollment) is done off-chain, and participants save data on their local disk and execute computations on their local Turing machines. In case no complaints are made the general properties from before hold. In case a complaint is made, the protocol falls to a slow on-chain interactive mode.

Interactive complaints: The idea of the interactive mode is to isolate a very specific computation needed in order to arbitrate the complaint. For this reason, every complaint must be made by a bonded entity, the “challenger” (generally, a participant, but sometimes external entities can complain whilst making a deposit) and against a bonded entity, the “accused”.

The interactive complaint protocol between the “challenger” and the “accused” proceeds in rounds, where in each round the “challenger” writes O(1) data (typically, a hash) to Ethereum according to some predetermined compute logic and the accused responds with a “yes” or a “no”. The next round then begins. Per round, the two sides have a time limit to respond via an on-chain transaction. The number of rounds is typically bounded by O(log t), and O(1) on-chain computation is invoked only in the final round.

Pre-compiled contracts: The interactive complaints reduce to basic computations, which in our context are group multiplications and exponentiations. These are typically too expensive to execute over Ethereum. In certain implementations, we can utilize of specific pre-compiled contracts (multiplication, exponentiation and pairing in specific elliptic curve groups) that have been incorporated into the EVM, e.g., in the Byzantium hard-fork. This may restrict us to very specific groups over which we were able to realize a threshold BLS-3 signature scheme.

Undelivered off-chain communication Off-chain communication introduces a subtle problem of undelivered data—a potential recipient cannot prove not receiving data. One approach to mitigate the problem in minimal costs is to use Ethereum memory to supply evidence (on-chain) that some data (not necessarily the prescribed data, but in the correct size) was indeed submitted.

### Another Example—Randomness Beacon

Having understood Eth-DKG, in certain implementations the described technologies can be configured to produce threshold signatures on specific messages at specific times. The unique nature of the signatures and their unforgeability (which is equivalent to their high entropy) make this a plausible randomness beacon as long as the signatures are not produced (by any entity) prior to the specified target time. The randomness beacon can be used for leader election which in turn realizes a lottery or leader-based consensus (for instance, a blockchain under the Proof-of-Stake paradigm).

In a simple lottery game—the total money raised selling lottery tickets would be R, where (1−α)R is the total prize and αR paid to the participants generating the randomness. The winner of the lottery is determined according to the unpredictable signature of some nothing-up-my-sleeve (known) value. If the signature is computed before the lottery ticket sale is over, whoever knows the signature could buy the winning ticket and win the (1−α)R. Collusion pressure is obviously high. The time periods to buy lottery tickets and reveal the signature would be determined by Ethereum block heights.

The main desired property of the system is that a participant in the cryptosystem would have no advantage if she gambled in the lottery. This setting fits our model accurately and if the parameters are tuned correctly, the framing mechanism eliminates collusion pressure, ensuring the secrecy economically. For example, for R=10⁶, Δ=10⁴ and α=6/10, we get t=501 and n=600 to ensure a 10% ROI (which is lucrative for, say, a week, or even a month long investment). The lottery distributes 400,000 in prizes and 600,000 to the n participants. As proven in the previous section, for collusion to take place two entities had to invest at least

$${\underline{( t + 1 ) Δ}}_{2}$$

which is over 2.5·10⁶.

Ped-DKG and Feldman's VSS Properties: The full description of the Ped-DKG protocol is given below. It utilizes what is referred to as Joint-Feldman to perform distributed key generation. The correctness and secrecy properties of Ped-DKG rely on a generalization of similar properties for a single Feldman VSS protocol.

Lemma 3 (Feldman). Feldman's VSS satisfies the following properties:

1. If the dealer Pᵢ is not disqualified during the protocol then all correct players hold shares that interpolate to a unique polynomial fᵢ of degree t. In particular, any t+1 of these shares suffice to efficiently reconstruct the secret fᵢ(0).

2. The protocol produces information (the public values X_{i,k} for k=0, . . . , t and private values x_{i,j} for j=1, . . . , n) that can be used at reconstruction time to test for the correctness of each share; thus, reconstruction is possible, even in the presence of malicious players, from any subset of shares containing at least t+1 correct shares.

3. The view of the adversary is independent of the value of the secret fᵢ(0), and therefore secrecy is unconditional.

Fig. Y: Ped-DKG:
1. Each player P, samples uniformly at random (and independently) t+1 coefficients from Z_{q}. These coefficients represent a “random” polynomial of degree t over Z_{q}, denoted fᵢ:

fᵢ(z)=a_{i,0}+a_{i,1}z+ . . . +a_{i,t}z^{t}
Pᵢ broadcasts X_{i,k}=g^{a}^{_{i,k}} for k=0, . . . , t. Each Pᵢ computes the sub-shares x_{i,j}=fᵢ(j) for j=1, . . . , n and privately sends x_{i,j} to player Pⱼ.
2. Each player Pⱼ verifies the sub-shares she received from the other players by checking

$$\text{?} = \text{?} ( \text{?} \text{?} \\ \text{?} \text{indicates text missing or illegible when filed}$$

for i=1, . . . , n.
If a check fails for some index i, Pⱼ broadcasts a complaint against Pᵢ.
3. In the case of a complaint against Pᵢ by Pⱼ, Pᵢ reveals the sub-share x_{i,j} (via the public broadcast communication channel). If any of the revealed sub-shares fails the above equation, Pᵢ is excluded from the set QUAL (i.e., disqualified). If more than t players complain against Pᵢ, she is also disqualified (as t+1 sub-shares reveal fᵢ by interpolation). From the assumption on the broadcast channel, the set QUAL is defined uniquely among the correct participants.
4. The global secret x itself is not computed by any player, but is equal to x=Σ_{i∈QUAL} a_{i,0}=f(0). The public key g^{x} can be calculated by any participant as Π_{i∈QUAL} X_{i,j}=g^{f(0)}.
   Additionally, the secret key share of every node is xⱼ=f(j)=Σ_{x∈QUAL} x_{i,j} and its corresponding public key g^{x}^{ⱼ} can be calculated by any of the participants from the public data which was published during the protocol run (using Lagrange interpolation).

While the generalization to the Ped-DKG protocol seems straightforward, the attack described herein shows there are delicate issues to address.

Threshold BLS-3 Signatures: As described herein, in certain implementations a randomness beacon can be realized using threshold BLS-3 signatures. For completeness, we specify the ingredients of the proposed signature scheme.

BLS Signatures. In certain implementations, a signature scheme can be based on the Weil pairing, which is remarkable in both its simplicity and efficiency. It results in signatures which are unique. This construction can rely on a set of problems which are closely related to the DLP, namely the Diffie-Hellman problem and its variants. Let G=hgi be a cyclic group of order q. We consider the following problems:

Decision Diffie-Hellman (DDHP). Let a, b, c∈Z_{g}. Given a tuple (g, g^{a}, g^{b}, g^{c}), decide whether g^{c}=g^{ab}.

Computational Diffie-Hellman (Co-DHP). Let a, b∈Z_{q}. Given a tuple (g, g^{a} g^{b}), compute g^{ab}.

A DDH (resp. Co-DHP) group is a group in which the DDH (resp. Co-DHP) is hard. A Gap Diffie-Hellman (GDH) group is one where the DDH is easy while the Co-DHP is still hard.

BLS utilizes GDH groups to design signatures which are easy to sign and verify: let G=hgi be a GDH group, and let x∈Z_{q} be the secret key, assumed to be known to the signer alone. Define X=g^{x} to be the public key known to all. To sign a message m∈G, the signer simply raises m to the power x, such that the signed message is M=m^{x}. Since DDH is easy in G, anyone can verify that M is really m^{x}, by solving the DDH (g, X, m, M). On the other hand, forging a signature is impossible since it amounts to solving the Co-DHP in G.

Pairings: BLS specifically use a GDH group arising from pairings efficiently computable maps admitting two useful properties:

Definition 2 (Pairing). Let G₁, G₂ and G_{T} be groups. A pairing e: G₁×G₂→G_{T} is a bilinear non-degenerate map.

Pairings give rise to GDH groups: if e is symmetric, i.e., G₁=G₂, and G₁ is a Co-DHP group, then G₁ is immediately a GDH group. The BLS construction uses a concrete symmetric pairing with G₁ a Co-DHP group over an elliptic curve. This choice results in sufficient security as well as in relatively short representation Later works done on pairings to establish the fact that asymmetric pairings can preform better in both these aspects.

Asymmetric pairings: In case G₁ 6=G₂ the pairing is said to be either of type-2 (if there is an efficiently computable isomorphism Ψ:G₂→G) or of type-3 (if there is no such Ψ). BLS-3 can be defined as a variant of the BLS scheme which utilizes type-3 pairings. This allows using groups with much shorter representation, while maintaining sufficient security. The essential change in BLS-3 is the underlying hardness assumption, which is a variant of Co-DHP, fit to the asymmetric setting:

Co-DHP*. Let G₁=hg₁i, G₂=hg₂i be two cyclic groups of the same prime order q. Given h, g₁, g₁^{x}∈G₁ and g₂, g₂^{x}∈G₂ (where x∈Z_{q}), compute h^{x}∈G₁. In the type-3 setting, G₁ computations may be easier to execute. For this reason, messages in the BLS-3 scheme come from G₁—so that signatures (exponentiation of m∈G₁) could be computed easily. Moreover, it makes sense to have the public keys come from G₂, since a public key only needs to be computed once (during key generation).

Threshold BLS signatures. In certain implementations, a general method for adapting various signatures schemes to the threshold setting can be employed. This can help illustrate how to use the GJKR-DKG protocol to turn BLS to a threshold signature scheme.

Escrow-DKG over Ethereum: Also described herein is an example full specification of our Eth-DKG protocol—Escrow-DKG modified to work over the Ethereum blockchain. The modifications concern aspects including: working with specific elliptic curve groups, minimizing on-chain communication, and incorporating interactive proofs for complaint arbitration.

Pre-compiled contracts: Let e:G₁×G₂→G_{T} be the pairing described in relation to Ethereum. Since the public key comes from G₂ (as described herein), we would have liked to perform Eth-DKG over G₂. However, the pre-compiled contracts only allow for efficient computations in G₁. To circumvent this restriction, participants commit to their polynomial over both G₁ and G₂, by submitting X^{u}_{i,k}=g^{a}^{^{ij}}ᵤ (for u=1, 2). We then rely on the following simple observation: we say that two commitments X¹_{i,k}_{₀}, X³_{i,k}_{₀} are (G₁, G₂)-consistent if their discrete log (with respect to g₁ and g₂) are the same. X¹_{i,k}_{₀}, X²_{i,k}_{₀} are (G₁, G₂)-consistent if e(g₁, X²_{i,k}_{₀})=e(X¹_{i,k}_{₀}, g₂).

To verify that the sub-shares match the G₂ commitments, the smart contract would first verify that the G₁ commitments are consistent with the sub-shares (using the pre-compiled contracts for G₁ arithmetics) and then that all pairs X¹_{i,k}, X²_{i,k} are (G₁, G₂)-consistent (using the pre- compiled contract for pairing computation).

Optimistic off-chain approach: To reduce on-chain communication to minimum, in certain implementations the participants can be instructed to send all public and private data via peer-to-peer off-chain channels. In the optimistic scenario, enrollment is the only on-chain transaction. Pᵢ's enrollment transaction must contain additional information—Digᵢ:=Digest {X¹_{i,k}}, {X²_{i,k}}, in order to make sure that she sends the same commitments X^{u}_{i,k} to all participants.

In order to retain the ability to arbitrate complaints over Ethereum, all off-chain communication is delivered via signed Ethereum transactions. The signature authenticates the issuer's identity, which allows using it as evidence when complaints are filed.

Undelivered off-chain communication: In case Pⱼ did not receive a transaction from Pᵢ off-chain, she can submit a missing data transaction. If the data is public in nature, Pᵢ is asked to publish it over Ethereum. If the data is private, Pᵢ encrypts it using Pⱼ's public encryption key Γⱼ and then submits it to the smart contract (this is the reason for including Γⱼ in the enrollment transaction, even though it is redundant in the optimistic scenario). If the data is too large to be written on-chain, we propose to use Ethereum's memory which is much cheaper in terms of gas, though not persistent. This can prove that indeed, some data in the right size was delivered. Then, if still needed, a regular complaint (e.g., that writes only a limited amount of data on-chain) can be filed. Alternatively, some of data may be logged as Ethereum events which are also much cheaper in terms of gas, persistent, but may not be accessed directly by the smart contract.

The below Fig. gives a full description of the Eth-DKG. To keep the description concise, we assume the reader is familiar with Escrow-DKG (described above) and focus on the modifications made to Eth-DKG.

FIG. Z: Eth-DKG

0 Deployment. The protocol formally begins when the smart contract is deployed.

1 Enrollment. The relevant Ethereum accounts enroll to the protocol by submitting enrollment transactions on-chain

tx₁′(i)=[Δ,Γᵢ,Digᵢ]

This is the only transaction (excluding complaints) in Eth-DKG which is sent on-chain.

2 Commitments. Every participant Pᵢ sends (off-chain) to all other participants Pj her commitments transaction.

tx′₂(i)=[{x_{i,k}¹}ₖ₌₀^{t},{X_{i,k}²}ₖ₌₀^{t}]

If some Pⱼ received tx₂(i) that does not match Digᵢ she can file a complaint cm₁′(j, i). If else some pair of commitments {X¹_{i,k}_{₀}, X²_{i,k}_{₀}} are not (G₁, G₂)-consistent, Pⱼ can file a complaint cm′₂(j, i, k₀).

3 Sub-shares. Every participant P, sends (over a private communication channel) to any other participant Pⱼ her corresponding sub-share transaction.

tx₃′(i,j)=[x_{i,j}]

4 Sub-shares Verification Every participant Pⱼ locally verifies the sub-shares sent to her are consistent with the G₁ commitments she received, namely that for all i,

$$\text{?} = {\prod }_{k = 0}^{t} {( {X}_{i , k}^{1} )}^{{j}^{k}}$$

$$\text{?} \text{indicates text missing or illegible when filed}$$

If the equality for some i′ does not hold, she can file a complaint cm₃′(j, i′).

If no complaints were filed during the course of the protocol, the Eth-DKG is said to have completed successfully (the deposits are kept for the application stage). Note that the public key of the scheme is g^{x}₂, and is computed by every participant locally. If needed, anyone may publish the public key on-chain In case of a complaint during the course of the protocol, the smart contract performs the arbitration and the protocol is relaunched.

Undelivered communication: In case Pⱼ did not receive tx₁(i) (for l∈{2, 3}) in time, she can request Pᵢ to publish it on-chain by submitting a special alert to the smart contract. This alert initiates a special phase of on-chain communication During this phase Pᵢ is required to submit the missing transaction to the smart contract—if the missing data is public (l=2) she submits tx₂′(i) as is; otherwise, if it is private (l=3), she submits tx₃″(i, j)=[ENC(x_{i,j}, Γⱼ)]. If P still fails to submit her on-chain transaction in time, any Ethereum address C may file a complaint cm₄′(C, i, l) against her.

Interactive complaints over Ethereum: Consider the case where node j received from node i the sub-share x_{i,j} and the commitments X_{i,k} for k=0, . . . , t (all are signed by i). Node j then performs the following verification

$$\text{?} = {\prod }_{k = 0}^{t} {( {X}_{i , k}^{1} )}^{{j}^{k}}$$

$$\text{?} \text{indicates text missing or illegible when filed}$$

If this verification passes with success then j keeps her silence and the protocol proceeds as usual. Otherwise, j submits a complaint transaction against i: cm₄′(j, i). The filed complaint makes the contract go into a dispute phase between j (the “challenger”) and i (the “accused”). The underlying contract takes the role of the arbitrator and decides whose deposit is to be slashed.

To settle the dispute a naïve approach would be the challenger, j, sending the contract all of i's commitments; the sub-share x_{i,j}; and the contract can easily decide a winner by verifying equation 1. However, this approach requires abundance amount of computations, among very expensive EC arithmetic computations, and it necessitate large amount of data storage. This becomes a burden on Ethereum network, where resources are scarce, and does not allow the contract to scale with the parameter t (often correlated with the parameter n). Indeed, in the following we present a solution in the form of a multi-round on-chain interactive protocol where equation 1 is reduced to a single computation step. The cost of this solution is in logarithmic rounds number, yet in total the smart contract is able to decide a winner in logarithmic amount of (simple) computation steps and with use of logarithmic amount of data storage.

To conclude, note that the repetitive procedure is expected to always end after about O(log(t)) steps. Furthermore, we emphasize that any step is constant in the amount of computations and data storage use. Thus we conclude that the amount of computations and storage use is indeed logarithmic in t. Finally, to see why the execution of the dispute indeed outputs the correct winner, we emphasize that the dispute protocol is merely a binary search to find where the parties first disagree. Case 3.(a) illustrates the setting where the parties first disagree and thus by the challenger submitting a proof with the accused commitment is enough to settle the dispute. Case 3.(b) illustrates the setting where either the parties are in complete disagreement or in complete agreement on the values of ζ. If the parties completely disagree, only a proof (again, by the challenger) of the first commitment is required. If the parties completely agree, then the dispute of equation 1 arises from disagreement on its left-hand-side. Thus a proof of i's sub-share to j, x_{i,j}, is sufficient.
FIG. 4: Sub-share complaint.
   Let j be the challenger and i be the accused.
1. As preparatory measure each of the parties each computes locally:

$$Ϛ ( m ) = {\prod }_{m = 0}^{t} {( \text{?} )}^{{j}^{k}} for m - 0 , … , t$$

$$\text{?} \text{indicates text missing or illegible when filed}$$

We denote ζⁱ(*) and ζ^{j}(*) as to the computations i and j do respectively.
2. The dispute phase progresses in rounds, where in each round, i and j interact by submitting transactions to the contract in turns^{a} and the contract updates its state. The contract initializes with l←0, h←t, last_{agree}=last_{disagree}=∅, .visited [0, . . . , t]=[0, . . . , 0].
   While h−l>1 or visited[l]=0 or visited[h]=0.
      For

$$m = l + \vert \frac{\text{?}}{2} \vert$$

$$\text{?} \text{indicates text missing or illegible when filed}$$

(if visited[m]=∅ then m=l),
(a) i subunits a transaction with ζⁱ(m). The contract updates: last←ζⁱ(m).
(b) j subunits a transaction with the string b where:

$$b = \{ \begin{matrix}‘ agree ’ & if {Ϛ}^{i} ( m ) = \text{?} ( m ) \\ ‘ disagree ’ & otherwise\end{matrix} \\ \text{?} \text{indicates text missing or illegible when filed}$$

If b=‘agreeⁱ, the contract updates: last_{agree}←last, l←m.
Otherwise, the contract updates: last_{disagree}←last, h←m.
Finally, the contract updates: visited[m]=1.
3. Once the stopping condition is met there ae two cases:
   (a) h−l=1, j submits the contract a proof with the commitment, X_{i,l+i}, signed by i. The contract verifies:

$${last}_{agree} \cdot ( \text{?} = {last}_{disagree} \\ \text{?} \text{indicates text missing or illegible when filed}$$

If the equality holds the accused wins otherwise the challenger wins.
(b) h=l. If h=0, j submits the contract a proof with the commitment, X [symbol] , signed by i. The contract verifies:

$${last}_{disagree} = {X}_{i , 0}$$

Otherwise, i=t, j submits the contract a proof with the sub-share x [symbol] . The contract (after decrypting it with i's secret key) verifies:

$${last}_{agree} = \text{?}$$

$$\text{?} \text{indicates text missing or illegible when filed}$$

If the equalities hold the accused wins otherwise the ciallenger wins. ^{a} If one of them, in her turn, fails to submit a valid transaction within a predetermined (block) time, she will forfeit the dispute and her deposit will be slashed.

It can therefore be appreciated that the described technologies are directed to and address specific technical challenges and longstanding deficiencies in multiple technical areas, including but not limited to cryptography, cybersecurity, and distributed and decentralized systems. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

Various methods disclosed herein can be performed by processing logic that can comprise hardware (circuitry, dedicated logic, etc.), software (such as is run on a computing device such as those described herein), or a combination of both. In one implementation, the described methods can be performed by one or more elements depicted and/or described herein, while in some other implementations, the one or more operations can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

It should also be noted that while the technologies described herein are illustrated primarily with respect to decentralized key generation and distribution over a blockchain-based network, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system(e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 1 is a block diagram illustrating components of a machine 100, according to some example implementations, able to read instructions from a machine-readable medium (e.g., a machine-readable storage medium) and perform any one or more of the methodologies discussed herein Specifically, FIG. 1 shows a diagrammatic representation of the machine 100 in the example form of a computer system, within which instructions 116 (e.g., software, a program, an application, an applet, an app, or other executable code) for causing the machine 100 to perform any one or more of the methodologies discussed herein can be executed. The instructions 116 transform the general, non-programmed machine into a particular machine programmed to carry out the described and illustrated functions in the manner described. In alternative implementations, the machine 100 operates as a standalone device or can be coupled (e.g., networked) to other machines. In a networked deployment, the machine 100 can operate in the capacity of a server machine or a client machine in a server-client network environment, or as a peer machine in a peer-to-peer (or distributed) network environment. The machine 100 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 116, sequentially or otherwise, that specify actions to be taken by the machine 100. Further, while only a single machine 100 is illustrated, the term “machine” shall also be taken to include a collection of machines 100 that individually or jointly execute the instructions 116 to perform any one or more of the methodologies discussed herein.

The machine 100 can include processors 110, memory/storage 130, and I/O components 150, which can be configured to communicate with each other such as via a bus 102. In an example implementation, the processors 110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 112 and a processor 114 that can execute the instructions 116. The term “processor” is intended to include multi-core processors that can comprise two or more independent processors (sometimes referred to as “cores”) that can execute instructions contemporaneously. Although FIG. 1 shows multiple processors 110, the machine 100 can include a single processor with a single core, a single processor with multiple cores (e.g., a multi-core processor), multiple processors with a single core, multiple processors with multiples cores, or any combination thereof.

The memory/storage 130 can include a memory 132, such as a main memory, or other memory storage, and a storage unit 136, both accessible to the processors 110 such as via the bus 102. The storage unit 136 and memory 132 store the instructions 116 embodying any one or more of the methodologies or functions described herein. The instructions 116 can also reside, completely or partially, within the memory 132, within the storage unit 136, within at least one of the processors 110 (e.g., within the processor's cache memory), or any suitable combination thereof, during execution thereof by the machine 100. Accordingly, the memory 132, the storage unit 136, and the memory of the processors 110 are examples of machine-readable media.

As used herein, “machine-readable medium” means a device able to store instructions (e.g., instructions 116) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 116. The term “machine-readable medium” shall also be taken to include any medium, or combination of multiple media, that is capable of storing instructions (e.g., instructions 116) for execution by a machine (e.g., machine 100), such that the instructions, when executed by one or more processors of the machine (e.g., processors 110), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 150 can include a wide variety of components to receive input, provide output, produce output, transmit information, exchange information, capture measurements, and so on. The specific I/O components 150 that are included in a particular machine will depend on the type of machine. For example, portable machines such as mobile phones will likely include a touch input device or other such input mechanisms, while a headless server machine will likely not include such a touch input device. It will be appreciated that the I/O components 150 can include many other components that are not shown in FIG. 1. The I/O components 150 are grouped according to functionality merely for simplifying the following discussion and the grouping is in no way limiting. In various example implementations, the I/O components 150 can include output components 152 and input components 154. The output components 152 can include visual components (e.g., a display such as a plasma display panel (PDP), a light emitting diode (LED) display, a liquid crystal display (LCD), a projector, or a cathode my tube (CRT)), acoustic components (e.g., speakers), haptic components (e.g., a vibratory motor, resistance mechanisms), other signal generators, and so forth. The input components 154 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 150 can include biometric components 156, motion components 158, environmental components 160, or position components 162, among a wide array of other components. For example, the biometric components 156 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 158 can include acceleration sensor components (e.g., accelerometer), gravitation sensor components, rotation sensor components (e.g., gyroscope), and so forth. The environmental components 160 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 162 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 150 can include communication components 164 operable to couple the machine 100 to a network 180 or devices 170 via a coupling 182 and a coupling 172, respectively. For example, the communication components 164 can include a network interface component or other suitable device to interface with the network 180. In further examples, the communication components 164 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 170 can be another machine or any of a wide variety of peripheral devices (e.g., a peripheral device coupled via a USB).

Moreover, the communication components 164 can detect identifiers or include components operable to detect identifiers. For example, the communication components 164 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 164, such as location via Internet Protocol (IP) geolocation, location via Wi-Fi® signal triangulation, location via detecting an NFC beacon signal that can indicate a particular location, and so forth.

In various example implementations, one or more portions of the network 180 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 180 or a portion of the network 180 can include a wireless or cellular network and the coupling 182 can be a Code Division Multiple Access (CDMA) connection, a Global System for Mobile communications (GSM) connection, or another type of cellular or wireless coupling. In this example, the coupling 182 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 1G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 116 can be transmitted or received over the network 180 using a transmission medium via a network interface device (e.g., a network interface component included in the communication components 164) and utilizing any one of a number of well-known transfer protocols (e.g., HTTP). Similarly, the instructions 116 can be transmitted or received using a transmission medium via the coupling 172 (e.g., a peer-to-peer coupling) to the devices 170. The term “transmission medium” shall be taken to include any intangible medium that is capable of storing, encoding, or carrying the instructions 116 for execution by the machine 100, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
enrolling a first device to a distributed key generation application executing across one or more nodes within a decentralized system;
generating, at the first device, a local secret comprising a polynomial function and one or more first coefficients;
calculating one or more first commitments for the polynomial function;
transmitting the one or more computed commitments to one or more nodes within the decentralized system;
computing a value of the polynomial function with respect to an identifying value that corresponds to a second device;
encrypting the computed value of the polynomial function with a public key associated with the second device;
transmitting the encrypted value of the polynomial function to one or more nodes within the decentralized system;
decrypting an encrypted value of the polynomial function computed by the second device with respect to an identifying value that corresponds to the first device;
validating that the decrypted value of the polynomial function computed by the second device corresponds to a commitment transmitted by the second device to one or more nodes within the decentralized system;
combining the value of the polynomial function computed by the second device with one or more values of the polynomial function computed by one or more other devices to generate a private key share associated with the first device; and
combining the value of the commitments computed by the second device with one or more values of the polynomial function computed by the first device and one or more other devices to generate a master public key and a public key share for the other participating devices.

2. The system of claim 1, wherein enrolling to the distributed key generation application comprises transmitting an instruction to transfer, within the decentralized system, a deposit to an address associated with the key generation application.

3. The system of claim 1, further comprising encrypting a message with the private key share associated with the first device such that, when aggregated with one or more messages encrypted with one or more other key shares, signs the message.

4. The system of claim 1, wherein one or more devices participating in the distributed key generation provide a deposit in order to participate.

5. The system of claim 4, wherein the deposit is based on an asset managed on the decentralized system and the deposit is placed using the decentralized system.

6. The system of claim 4, wherein the deposit is based on an asset managed on a smart contract deployed on the decentralized system.

7. The system of claim 1, wherein the device can submit a complaint upon detection that another participating device not conforming to the protocol.

8. The system of claim 7, wherein the dispute between the devices is resolved by the blockchain or a smart contract operating on top of it.

9. The system of claim 7, wherein the dispute between the devices is resolved by a challenge and response process.

10. The system of claim 7, wherein the device submits the complaint to the blockchain system or a smart contract deployed on it.

11. The system of claim 7, wherein upon detection of a device misbehavior, the misbehaving device is penalized by the system.

12. The system of claim 7, wherein the penalty includes slashing of funds by the blockchain system that were deposited by the device as part of the enrolment or in a separate process.

13. The system of claim 7, wherein the misbehavior of the misbehaving device is taken into consideration by other incentive mechanisms related to the blockchain system.

14. The system of claim 7, wherein the device that detected the misbehavior is rewarded by the system based on the misbehaving device deposit.

15. The system of claim 1, wherein in case a device fails to keep one more of its secret shares secret, anyone that knows them can submit them to the system and penalize the device.

16. The system of claim 15, wherein the one that identified a participating device secret share is rewarded by the blockchain system, potentially based on the device's deposit.

17. The system of claim 1, wherein one or more devices that participate in the distributed key generation also operate a node in the blockchain used for the distributed key generation protocol.

18. The system of claim 1, wherein protocol uses one or more smart contracts deployed on the blockchain.

19. The system of claim 1, wherein the blockchain used for the distributed key generation protocol is Ethereum.

20. The system of claim 19, wherein specific Ethereum optimizations are applied to the protocol.

21. The system of claim 19, wherein Elliptic curve that matches Ethereum's pre-compiled smart contracts is used for the threshold scheme, reducing the Ethereum computation cost.

22. The system of claim 1, wherein the distributed key generation protocol can complete successfully even in the presence of malicious/misbehaving participating devices.

23. The system of claim 1, wherein some calculations are offloaded to an off-chain calculation outside the blockchain system.

24. The system of claim 1, wherein some calculations are offloaded to another blockchain.

25. The system of claim 1, wherein the device participates in one or more distributed key generation processes in parallel, potentially with different other participants.

26. The system of claim 1, wherein the generate key shares are used by the device along other participants to sign with a threshold signature.

27. The system of claim 26, wherein the threshold signature is used in order to generate a random data source.

28. The system of claim 26, wherein a device may detect a misbehavior of the signing device and potentially report or penalize it.

29. The system of claim 1, wherein the generate key shares are used by the device along other participants to encrypt or decrypt data.

30. The system of claim 29, wherein a device may detect a misbehavior of a device that participating in the encryption or decryption and potentially report or penalize it.

31. The system of claim 1, wherein the distributed key generation process time is monitored by the blockchain or a smart contract operated on top of it and stops or restarts the process upon timeout.

32. The system of claim 1, wherein part of protocol is performed by direct communication between the device and other devices.

33. The system of claim 1, wherein a misbehaving participant is identified and removed from participating in future distributed key generation processes.

34. The system of claim 1, wherein at the end of the distributed key generation process, the device obtains the public key shares of the other participants in the process.

35. A system comprising:
a processing device; and
a memory coupled to the processing device and storing instructions that, when executed by the processing device, cause the system to perform one or more operations comprising:
receiving, at a node that executes a distributed key generation application within a decentralized system, an enrollment of a first device;
receiving, from the first device, one or more first commitments computed with respect to a polynomial function in relation to one or more other devices enrolled to the key generation application;
receiving, from the first device, a value of the polynomial function computed with respect to an identifying value that corresponds to a second device and encrypted with a public key associated with the second device;
providing the encrypted value to the second device; and
initiating one or more actions based on a verification output provided by the second device.

36. The system of claim 35, wherein initiating one or more actions comprises: based on a determination by the second device that the polynomial function computed by the first device does not correspond to one or more of the first commitments provided by the first device, with respect to an identifying value that corresponds to a second device, terminating an instance of the key generation application.

37. The system of claim 35, wherein initiating one or more actions comprises: based on a determination by the second device that the polynomial function computed by the first device does not correspond to one or more of the first commitments provided by the first device, with respect to an identifying value that corresponds to a second device, initiating a penalty with respect to the first device.

38. The system of claim 35, wherein initiating one or more actions comprises: based on a determination by the second device that the polynomial function computed by the first device does not correspond to one or more of the first commitments provided by the first device, with respect to an identifying value that corresponds to a second device, initiating a penalty with respect to a deposit provided in conjunction with the enrollment of the first device

34. A method comprising:
enrolling a first device to a distributed key generation application executing across one or more nodes within a decentralized system;
generating, at the first device, a local secret comprising a polynomial function and one or more first coefficients;
calculating one or more first commitments for the polynomial function;
transmitting the one or more computed commitments to one or more nodes within the decentralized system;
computing a value of the polynomial function with respect to an identifying value that corresponds to a second device;
encrypting the computed value of the polynomial function with a public key associated with the second device;
transmitting the encrypted value of the polynomial function to one or more nodes within the decentralized system;
decrypting an encrypted value of the polynomial function computed by the second device with respect to an identifying value that corresponds to the first device;
validating that the decrypted value of the polynomial function computed by the second device corresponds to a commitment transmitted by the second device to one or more nodes within the decentralized system; and
combining the value of the polynomial function computed by the second device with one or more values of the polynomial function computed by one or more other devices to generate a private key share associated with the first device.

35. A non-transitory computer readable medium having instructions stored thereon that, when executed by a processing device, cause the processing device to perform operations comprising:
enrolling a first device to a distributed key generation application executing across one or more nodes within a decentralized system;
generating, at the first device, a local secret comprising a polynomial function and one or more first coefficients;
calculating one or more first commitments for the polynomial function;
transmitting the one or more computed commitments to one or more nodes within the decentralized system;
computing a value of the polynomial function with respect to an identifying value that corresponds to a second device;
encrypting the computed value of the polynomial function with a public key associated with the second device;
transmitting the encrypted value of the polynomial function to one or more nodes within the decentralized system;
decrypting an encrypted value of the polynomial function computed by the second device with respect to an identifying value that corresponds to the first device;
validating that the decrypted value of the polynomial function computed by the second device corresponds to a commitment transmitted by the second device to one or more nodes within the decentralized system; and
combining the value of the polynomial function computed by the second device with one or more values of the polynomial function computed by one or more other devices to generate a private key share associated with the first device.
